(19) United States
(12) Patent Application Publication
(10) Pub. No.: US 2020/0216156 A1
(43) Pub. Date: Jul. 9, 2020

(54) MOUTHPIECE CONFIGURED FOR ENGAGING A SNORKEL OR SCUBA DIVING REGULATOR AND DELIVERING A FLUID OR GEL INTO THE MOUTH OF THE USER

(71) Applicant: Ares Enterprises LLC, Salt Lake City, UT (US)

(72) Inventors: Matthew Gary Carter PIERCE, Kaysville, UT (US); Gary D.E. Pierce, Kaysville, UT (US)

(73) Assignee: Ares Enterprises LLC, Salt Lake City, UT (US)

(21) Appl. No.: 16/242,776

(22) Filed: Jan. 8, 2019

(51) Int. Cl. B63C 11/16; A23L 27/00

(52) U.S. Cl. CPC B63C 11/16; A23V 2002/00; A23L 27/84

(57) ABSTRACT

This invention relates to a mouthpiece configured for engaging a snorkel or a first and/or second SCUBA diving regulator having at least one internal receiving chamber formed in at least one of the opposing bite wings and configured to receive and retain a fluid or gel therein, whereby an effective amount of the fluid or gel may be selectively introduced through at least one selectively sealable fluid delivery opening formed in one or more of the bite wings and/or formed in a side wall of the internal receiving chamber, whereas upon application of sufficient pressure or force by the teeth of the user, an effective amount of the fluid or gel flows into the user's mouth to overcome or substantially ameliorate the effects associated with salt mouth. The fluid or gel introduced into the internal receiving chamber may be selected from the group consisting of fresh water, diluted mouthwash, or a flavored fluid or gel comprising sweetened or unsweetened flavors selected from the group consisting of grape, strawberry, berry, black cherry, raspberry, coconut, banana, peach, chocolate, caramel, vanilla, mint, fruit punch, mango, bubble gum or the like.

### FIELD OF THE INVENTION

This invention generally relates to underwater snorkeling or diving equipment and, more specifically, to a mouthpiece for a snorkel or SCUBA regulator having at least one internal receiving chamber formed in one or more of the opposing bite wings and configured to receive and selectively retain a fluid or gel therein, whereby an amount of the fluid or gel may be dispensed or passed through at least one selectively sealable opening that is formed in at least one of the bite wings upon application of sufficient pressure or force applied by the respective teeth of the user.

### BACKGROUND

Evidence suggests that snorkeling dates back many centuries ago and may have even originated in Crete some 5,000 years ago as sea sponge farmers used hollowed out reeds to submerge and retrieve natural sponges for trade and commerce. Aristotle, the Greek philosopher, recalled instances of divers using “instruments for respiration” that resembled the shape of an elephant tusk.

It would seem that credit for the first contemporary snorkel was seemingly attributed to Leonardo Da Vinci and his hollow-tube creation that was designed to be attached to a diver's leather head covering or helmet. Today, the same basic concept provides the means for snorkelers to breath air from the surface with their face submerged under water for a period of time. As a result of the advances in rubber and plastic composite materials, the most popular snorkels that are used today may be configured to employ J-shaped plastic tubes connected by a flexible strap or clip assembly to a diver's mask or swim goggles.

As appreciated, snorkeling has become a popular recreational activity, particularly at tropical locations and amid coral reefs where sea life is usually the most abundant.

Snorkeling has been found to be a generally safe and fun way to observe underwater sea life in a natural setting and appeals to all ages because of how little effort it takes.

In 1942, a rebreathing underwater device, also known as a Self-Contained Underwater Breathing Apparatus (SCUBA), was invented by Jacques Cousteau and Emile Gagnan which actually worked. A decade or so later, recreational scuba diving became a popular activity providing individuals with the ability to become completely submerged under the water for extended periods of time, thus providing a means allowing for expansive exploration of the open waters.

Today, an estimated 500,000 new scuba divers are certified yearly in the United States. In North America alone, recreational diving has become a multi-billion dollar industry. It is anticipated, that more and more people will take up scuba diving and that the ones that already are certified scuba divers will continue to explore new underwater destinations and engage in more challenging opportunities such as deeper diving, technical diving, free-diving and/or cave-diving.

While snorkeling or using a SCUBA regulator to explore the underwater sea life or ship wrecks, there is at least one problem with engaging in these activities that has not yet been remedied. Speaking from personal experience, as avid snorkelers and certified scuba divers, we, as the inventors of the present invention, and probably everyone that has ever tried snorkeling or SCUBA diving have, more likely than not, experienced the negative effects associated with “salt mouth” or “dry mouth.” Salt mouth or dry mouth, referred to herein as “salt mouth,” typically occurs when seawater enters the snorkeler's or scuba diver's mouth. The salt in the seawater not only has an unpleasant taste, it tends to dry out the user's mouth causing discomfort and, in some instances, may result in numb or raw sensations within the mouth the longer that the salty taste remains. Moreover, it has been found that salt mouth can inflame the throat and make swallowing nearly impossible.

To address the discomfort and other issues associated with salt mouth, those skilled in the art developed a self-contained underwater drinking apparatus (SCUDA) for use by scuba divers which includes: (1) a container for fluid, (2) a tube connected to the container for receiving the fluid from the container and (3) a mouthpiece integral with the tube for receiving the fluid from the tube. The mouthpiece may be attached to a regulator supplying air to the diver. In operation, the SCUDA device provides a diver with both fluid and air through a single mouthpiece, thus facilitating a means of hydration to the user.

As appreciated by those skilled in the art, the hydration pouches of the prior art, inclusive of the SCUDA device, are typically configured in such a manner to be selectively attached to one or more of the air tanks or, in the alternative, can be attached directly to the body of the user. To operate, the diver manually squeezes the body of the pouch in order to receive the desired amount of fluid directly into his mouth or, as in the instance of the SCUDA device, through the mouthpiece and into the user's mouth.

Although SCUDA and other hydration bladders or pouches can be used by scuba divers to provide hydration, these units are typically bulky and can cost several hundred to thousands of dollars. Correspondingly, it is uncommon for a person that is snorkeling for the fun and adventure to have actually be using one of these hydration pouches or devices attached to them. To this end, what is needed for those that snorkel or scuba dive is a mouthpiece configured to engage a snorkel or a SCUBA regulator and having a flavored fluid or gel selectively stored within a receiving chamber formed in a portion of the body of the mouthpiece, whereby the flavored fluid or gel can be delivered under an application of pressure into the user's mouth in an effective amount sufficient to overcome or substantially ameliorate the discomfort and conditions associated with salt mouth.

Therefore, the present invention seeks to provide a mouthpiece for a snorkel or SCUBA regulator having at least one internal receiving chamber formed in one or more of the opposing bite wings and configured to receive and selectively retain an amount of fresh water, a diluted mouthwash, or a flavored fluid or gel therein. In one embodiment, the fluid or gel may be introduced into the internal receiving chamber formed in at least one of the bite wings through a selectively sealable opening formed in a wall of the bite wing. Then, upon application of sufficient pressure or force by a user on the corresponding bite wing having the internal receiving chamber containing the fluid or gel, such as bitting down on the bite wing, an effective amount of the fluid or gel may be selectively dispensed through at least one selectively sealable fluid delivery opening formed in the body of the bite wing. In one embodiment, one or more selectively sealable fluid delivery openings are formed in each of the opposing bite wings of the mouthpiece. As appreciated, an effective amount of the fluid or gel consists of enough to overcome or substantially ameliorate the discomfort and effects associated with salt mouth commonly experienced by snorkelers and scuba divers. Importantly, the present invention provides an inexpensive alternative to SCUDA devices and other hydration bladders and comprises a design generally configured to fit most snorkels and SCUBA regulators.

### SUMMARY AND OBJECTS OF THE INVENTION

In view of the foregoing, it is a primary object of the present invention to provide a mouthpiece for a snorkel or SCUBA diving regulator configured to receive and dispense an effective amount of a fluid or gel sufficient to overcome or substantially ameliorate the effects associated with salt mouth.

It is a further object of the present invention to provide a mouthpiece configured for engaging a snorkel or a first and/or second SCUBA diving regulator having at least one internal receiving chamber formed in one or more of the opposing bite wings and configured to receive and retain fresh water, a diluted mouthwash, or a flavored fluid or gel therein, whereby an effective amount of the fluid or gel may be selectively dispensed through at least one selectively sealable fluid delivery opening formed in one or more of the bite wings, whereas upon application of sufficient pressure or force by the teeth of the user, an effective amount of the fluid or gel flows into the user's mouth to overcome or substantially ameliorate the effects associated with salt mouth.

Additionally, it is an object of the present invention to provide a mouthpiece made of a flavored silicone or other suitable material configured to engage a snorkel or SCUBA regulator, wherein the mouthpiece having at least one internal receiving chamber formed in one or more of the opposing bite wings and configured to receive and retain a fluid or gel therein, whereby an effective amount of the fluid or gel may be selectively dispensed through at least one selectively sealable fluid delivery opening formed along a side wall of the receiving chamber or, alternatively, along at least a portion of the length of the upper and/or lower surfaces, respectively, of one or more of the bite wings upon application of sufficient pressure or force applied by the teeth of the user, whereby an effective amount of the fresh water, diluted mouthwash, or flavored fluid or gel correspondingly flows into the user's mouth to overcome or substantially ameliorate the effects associated with salt mouth.

It is a still further object of the present invention to provide a mouthpiece configured for engaging a snorkel or SCUBA regulator having at least one internal receiving chamber formed in each of the opposing bite wings having an internal periphery, wherein each of the receiving chambers comprise a selectively sealable opening configured for introducing a fluid or gel within the internal periphery of the receiving chambers. Each of the opposing bite wings being formed having at least one opening formed in at least a portion of the length of a side wall of the receiving chamber or along a portion of the length of the upper and/or lower surfaces for selectively dispensing the fluid or gel upon application of sufficient pressure or force applied by the teeth of the user, whereby an effective amount of the fresh water, diluted mouthwash, or flavored fluid or gel flows into the user's mouth to overcome or substantially ameliorate the effects associated with salt mouth.

Consistent with the foregoing objects, the present invention is directed to a mouthpiece formed of silicone, rubber or other suitable material and having a first body portion formed to selectively engage a snorkel or a first and/or second stage SCUBA diving regulator. In one embodiment of the present invention, the mouthpiece comprises an opening formed in the first body portion, wherein the opening is configured in a corresponding shape adaptable to provide a sealing engagement with a snorkel or a first and/or second stage diving regulator so as to provide an internal conduit sufficient to allow for the passage of air between the snorkel or the first and/or second diving regulators and the mouthpiece.

Extending contiguously from the first body portion and the opening formed therein, the mouthpiece comprises a second body portion configured for being selectively introduced into the mouth of a user. In one embodiment of the present invention, the second body portion of the mouthpiece comprises a flanged wall formed in a substantially semi-circular or “U” shaped configuration and defining an outer surface and an inner surface, with a thickness therebetween. An internal conduit is formed along a portion of the length of the inner surface of the flanged wall and configured to engage the opening formed in the first body portion so as allow for the passage of air between the snorkel or the first and/or second diving regulators and the mouthpiece. In addition, a first bite wing and a second bite wing may be formed on opposing sides of the inner surface of the flanged wall.

The first bite wing and the second bite wing are generally configured having an upper surface and a lower surface that extend substantially perpendicular to the inner surface of the flanged wall. In an embodiment of the present invention, the upper surface of both the first bite wing and the second bite wing, respectively, form a bend extending generally upward at the furthermost width of the upper surface of the bite wing opposite the inner surface of the flanged wall, thereby forming an upper side wall. The upper surface of each of the first and second bite wings are generally configured having a surface area sufficient in size and dimension to engage some of the upper teeth of the user between the flanged wall and the upper side wall of the respective bite wing therebetween.

Likewise, the lower surface of both the first bite wing and the second bite wing, respectively, form a bend extending generally downward at the furthermost width of the lower surface of the bite wing opposite the inner surface of the flanged wall, thereby forming a lower side wall. The lower surface of each of the first and second bite wings are generally configured having a surface area sufficient in size and dimension to engage some of the lower teeth of the user between the flanged wall and the lower side wall of the bite wing therebetween.

In one embodiment of the present invention, the upper and lower surfaces of the first and second bite wings may be formed having a smooth surface area for the respective teeth of the user to engage. In other embodiments of the present invention, the upper and/or lower surfaces of the first and second bite wings may be formed having surface areas, respectively, that are formed in such a manner to reduce slippage of the engaging teeth when the mouthpiece is inserted into the mouth of the user. For example, and not by way of limitation, the surface area of the upper and lower surfaces of the bite wings may be formed having a roughened surface area or a surface area including one or more raised nodules, both being sufficient for the teeth to engage, thereby reducing slippage of the engaging teeth when the mouthpiece is inserted and retained within the mouth of the user.

Integrally formed between the upper and lower surfaces of at least one of the bite wings is a receiving chamber having an internal periphery configured for receiving an amount of a flavored fluid or gel. In one embodiment of the present invention, the receiving chamber may be defined by the upper and lower surfaces of the bite wing correspondingly providing an upper wall and a lower opposing wall, together with a front wall and a back wall, and a side wall formed opposite the inner surface of the flanged wall. In one embodiment, the internal receiving chamber includes a selectively sealable fluid receiving opening formed within the front wall, wherein the fluid receiving opening is configured for selectively receiving therethrough an amount of fresh water, diluted mouthwash, or a flavored fluid or gel being passed into the internal periphery of the receiving chamber upon introduction of a leading end of a delivery member, such as, for example but not by way of limitation, a syringe, containing a supply of the fluid or gel. Upon removal of the leading end of the delivery member after introducing the fluid or gel into the internal periphery of the receiving chamber, the fluid receiving opening formed within the front wall of the receiving chamber selectively reseals the internal periphery of the receiving chamber thereby retaining the amount of fresh water, diluted mouthwash, or flavored fluid or gel introduced therein.

In one embodiment of the present invention, an internal receiving chamber having an internal periphery configured for receiving an amount of fluid or gel in both the first and second bite wings of the mouthpiece. Accordingly, a selectively sealable fluid receiving opening may be formed within the front wall of the first and second bite wings, respectively, wherein an amount of fresh water, diluted mouthwash, or flavored fluid or gel may be selectively introduced into the internal periphery of the corresponding internal receiving chambers. Wherein the selectively sealable fluid receiving openings are configured to receive the introduction of a leading end of a delivery member containing a supply of the fluid or gel used to introduce the fluid or gel into the internal receiving chambers, respectively. In operation, upon removal of the leading end of the flavored fluid delivery member, the fluid receiving openings selectively seal the internal receiving chamber.

In order to deliver the fresh water, diluted mouthwash, or flavored fluid or gel contained within the internal receiving chamber of the first bite wing and/or the second bite wing into the mouth of the user, at least one selectively sealable fluid delivery opening may be formed in the corresponding side wall of the internal receiving chamber formed within the bite wing for selectively dispensing the fluid or gel therethrough upon an application of sufficient pressure or force that is applied by the teeth of the user to the upper and lower surfaces of the corresponding bite wing. Upon application of pressure or sufficient force on the upper and lower surfaces of one or more of the bite wings, an amount of the fresh water, diluted mouthwash, or flavored fluid or gel housed within the respective internal receiving chamber will be delivered through one or more openings formed in the corresponding side wall and into the user's mouth. As appreciated, the amount of fluid or gel that is dispensed into the mouth of the user through at least one selectively sealable fluid delivery opening will depend on the user's need to satisfactorily overcome or substantially ameliorate the effects associated with salt mouth that the user is experiencing while snorkeling or SCUBA diving.

In some embodiments of the present invention, at least one internal receiving chamber is formed in the first bite wing and at least one internal receiving chamber is formed in the second opposing bite wing. The internal receiving chambers are configured in the manner, as described above, so as to receive and retain an amount of fluid or gel which may then be selectively delivered from the receiving chambers upon an application of a sufficient force to allow an amount of the fresh water, diluted mouthwash, or flavored fluid or gel to flow through one or more of the selectively sealable fluid delivery openings formed in the side wall of each of the receiving chambers formed in the first and second bite wings and into the user's mouth in an amount sufficient to overcome or substantially ameliorate the effects associated with salt mouth.

In another embodiment of the present invention, one or more selectively sealable fluid delivery openings may be formed along a portion of the length of the upper and/or lower surfaces of the first and/or the second bite wings for selectively dispensing the fluid or gel contained within the internal receiving chambers, respectively, upon an application of sufficient pressure or force applied by the teeth of the user to the upper and lower surfaces of the bite wings. Correspondingly, upon application of sufficient force or pressure on the first and/or second bite wings, an amount of the fresh water, diluted mouthwash, or flavored fluid or gel will be delivered through the one or more selectively sealable fluid delivery openings that are formed in the upper and/or lower surfaces of the bite wings, thereby dispensing the fluid or gel into the user's mouth in an amount sufficient to overcome or substantially ameliorate the effects associated with salt mouth.

As contemplated herein, fresh water or a diluted mouthwash may be introduced into the receiving chamber(s) of the mouthpiece. Additionally, a flavored fluid or gel may be introduced into the internal receiving chamber(s) of the mouthpiece which may comprise a variety of flavors. For example, the flavored fluid or gel, as contemplated by the present invention, may include sweetened or unsweetened flavors. Moreover, the flavored fluid or gel introduced into one or more of the receiving chambers formed in the opposing bite wings of the mouthpiece of the present invention may be selected from the group consisting of the following flavors: grape, strawberry, berry, black cherry, blueberry, raspberry, coconut, banana, peach, chocolate, caramel, vanilla, mint, fruit punch, mango, bubble gum or the like. In addition, the flavored fluid or gel that is to be introduced into the receiving chamber of the first and/or second bite wings of the mouthpiece may comprise a compositional solution or formulation that aids in overcoming and/or substantially ameliorating the discomfort and effects associated with salt mouth.

In one embodiment of the present invention, the fluid or gel may be first introduced into a delivery member, such as, for example, a syringe. The delivery member comprises a leading end having a size and shape sufficient for being introduced into the selectively sealable receiving opening formed in the front wall of the receiving chamber of the first and/or second bite wings to deliver an amount of fresh water, diluted mouthwash, or a particular flavor of the flavored fluid or gel into the internal receiving chamber, as desired by the user. As contemplated herein, the internal receiving chamber of the opposing bite wings, respectively, may be configured to receive one or more flavors of the flavored fluid or gel as personally desired by the user.

Additionally, in one embodiment of the present invention, the silicone, rubber or other material from which the mouthpiece may be formed may comprise a flavoring embedded within the compositional material. In this regard, for example, but not by way of limitation, the mouthpiece may be formed of a grape flavored silicone and include a grape flavored fluid or gel selectively introduced into one or more of the receiving chambers formed in one or more of the opposing bite wings. Whereas, upon application of a sufficient force or pressure applied by the user to the upper and/or lower surfaces of one or more of the bite wings, the grape flavoring introduced into the respective internal receiving chamber will pass through one or more selectively sealable fluid delivery openings formed in the side wall of the first and/or second receiving chamber and/or through one or more selectively sealable fluid delivery openings formed in the upper and/or lower surfaces of the first and/or second opposing bite wings.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of one embodiment of a mouthpiece of the present invention configured to selectively engage a snorkel or a first and/or second stage SCUBA diving regulator;

FIG. 2 is a cross sectional view of one embodiment of a receiving chamber formed in a bite wing of the mouthpiece of the present invention as illustrated in FIG. 1;

FIG. 3 is a perspective view of the mouthpiece as illustrated in FIG. 1 from the bottom side;

FIG. 4 is a perspective view of an alternate embodiment of a mouthpiece of the present invention configured to selectively engage a snorkel or a first and/or second stage SCUBA diving regulator;

FIG. 5 is a perspective view of the mouthpiece as illustrated in FIG. 4 from the bottom side;

FIG. 6 is a perspective view of yet another embodiment of a mouthpiece of the present invention configured to selectively engage a snorkel or a first and/or second stage SCUBA diving regulator;

FIG. 7 is a perspective view of the mouthpiece as illustrated in FIG. 1 from the bottom side;

FIG. 8 is a perspective view of an embodiment of a mouthpiece of the present invention configured to selectively engage a snorkel; and

FIG. 9 is a perspective view of an embodiment of a mouthpiece of the present invention configured to selectively engage a SCUBA diving regulator.

### DETAILED DESCRIPTION OF THE PREFERRED EMBODIMENTS

It will be readily understood that the structural components and features of the present invention, as generally described and illustrated in the Figures herein, could be arranged and designed in a wide variety of different configurations. Thus, the following more detailed description of various embodiments of the present invention, as represented in the drawings, is not intended to limit the scope of the invention, as claimed, but is merely representative of various embodiments of the invention. The illustrated embodiments of the present invention will therefore be best understood by reference to the drawings, wherein like parts are designated by like numerals throughout.

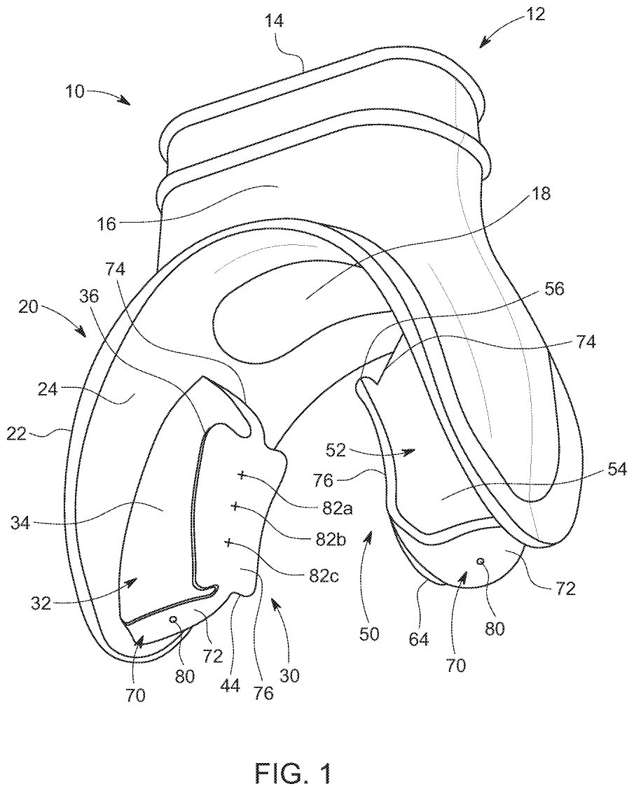

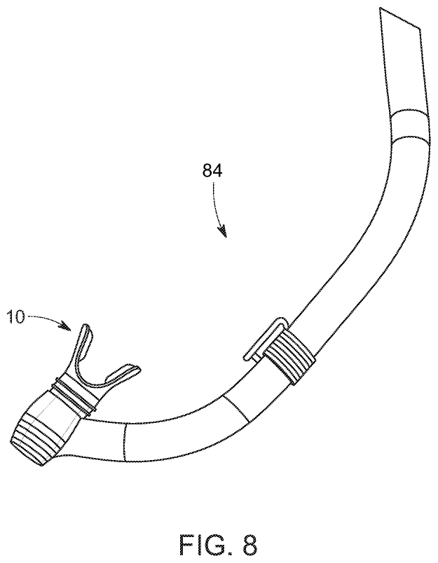

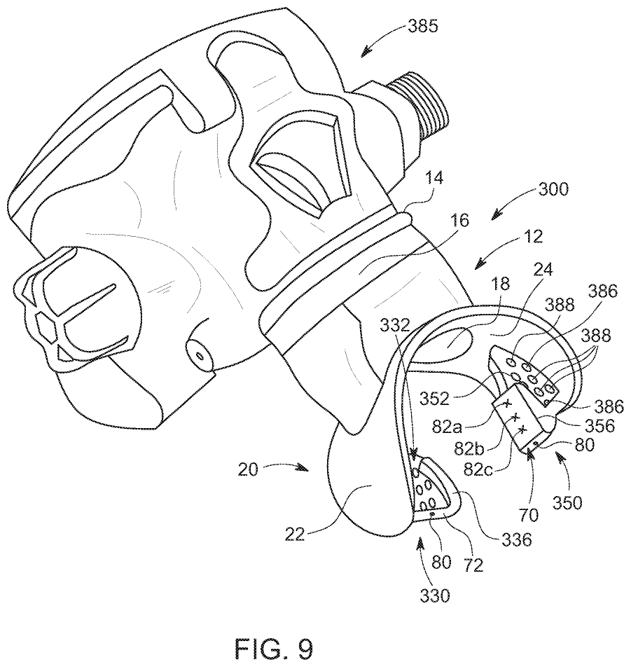

Referring to FIG. 1, an embodiment of a mouthpiece, designated generally as 10, is illustrated. As shown, the mouthpiece 10 includes a first body portion 12 and a contiguous second body portion 16. The first body portion 12 comprises a configuration designed to selectively engage a snorkel 84, as best shown in FIG. 8, or a first and/or second stage SCUBA diving regulator 385, as best shown in FIG. 9.

In one embodiment of the present invention, the mouthpiece 10 comprises an opening 14 formed in the first body portion 12, wherein the opening 14 is configured in a corresponding shape adaptable to provide a sealing engagement with a snorkel or a first and/or second stage SCUBA diving regulator so as to provide an internal conduit 18 sufficient to allow for the passage of air between the snorkel or the first and/or second SCUBA diving regulators and the mouthpiece 10, respectively.

Extending contiguously from the first body portion 12 and the opening 14 formed therein, the mouthpiece 10 comprises a second body portion 16 configured for being selectively introduced into the mouth of a user. In one embodiment of the present invention, the second body portion 16 of the mouthpiece 10 comprises a flanged wall 20 formed in a substantially semi-circular or “U” shaped configuration and defining an outer surface 22 and an inner surface 24, with a thickness defined therebetween. A portion of the internal conduit 18 may be formed along a portion of the length of the inner surface 24 of the flanged wall 20 and configured to engage the opening 14 formed in the first body portion 12 so as allow for the passage of air between the snorkel or the first and/or second SCUBA diving regulators and the mouthpiece 10, respectively. In addition, the second body portion 16 of the mouthpiece 10 may be formed having a first bite wing 30 and a second bite wing 50 formed on opposing sides of the inner surface 24 of the flanged wall 20.

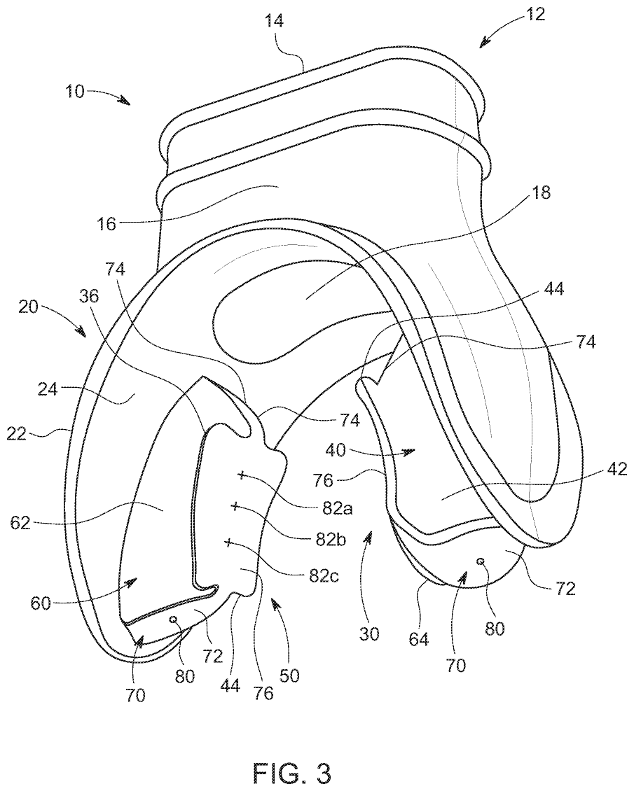

Referring now to FIGS. 1, 2 and 3, the first bite wing 30 may be configured comprising an upper surface 32 and an opposing lower surface 40, wherein both the upper surface 32 and the lower surface 40 are disposed substantially perpendicular to the inner surface 24 of the flanged wall 20. In one embodiment of the present invention, the upper surface 32 of the first bite wing 30 may be formed having an inwardly extending upward bend at the furthermost width of the upper surface 32 of the first bite wing 30 opposite the inner surface 24 of the flanged wall 20, thereby forming an upper side wall or flange 36. The upper surface 32 of the first bite wing 30 may also be generally configured having a surface area 34 sufficient in size and dimension to engage some of the corresponding upper teeth of the user between the inner surface 24 of the flanged wall 20 and the upper side wall or flange 36 of the bite wing 30 therebetween.

Similarly, the second bite wing 50 may be configured comprising an upper surface 52 and an opposing lower surface 60, wherein both the upper surface 52 and the lower surface 60 are disposed substantially perpendicular to the inner surface 24 of the flanged wall 20. In one embodiment of the present invention, the upper surface 52 of the second bite wing 50 may be formed having an inwardly extending upward bend at the furthermost width of the upper surface 52 of the second bite wing 50 opposite the inner surface 24 of the flanged wall 20, thereby forming an upper side wall or flange 56. The upper surface 52 of the second bite wing 50 may also be generally configured having a surface area 54 sufficient in size and dimension to engage some of the corresponding upper teeth of the user between the inner surface 24 of the flanged wall 20 and the upper side wall or flange 56 of the bite wing 50 therebetween.

Similar in configuration to the upper surface 32 of the first bite wing 30, the lower surface 40 of the first bite wing 30 may be formed having an inwardly extending downward bend at the furthermost width of the lower surface 40 opposite the inner surface 24 of the flanged wall 20, thereby forming a lower side wall or flange 44. The lower surface 40 of the first bite wing 30 may also be generally configured having a surface area 42 sufficient in size and dimension to engage some of the corresponding lower teeth of the user between the inner surface 24 of the flanged wall 20 and the lower side wall or flange 44 of the first bite wing 30 therebetween.

Similar in configuration to the lower surface 40 of the first bite wing 30, the lower surface 60 of the second bite wing 50 may be formed having an inwardly extending downward bend at the furthermost width of the lower surface 40 opposite the inner surface 24 of the flanged wall 20, thereby forming a lower side wall or flange 66. The lower surface 60 of the second bite wing 50 may also be generally configured having a surface area 62 sufficient in size and dimension to engage some of the corresponding lower teeth of the user between the inner surface 24 of the flanged wall 20 and the lower side wall or flange 64 of the second bite wing 50 therebetween.

In one embodiment of the present invention, the upper and lower surfaces 32, 40 of the first bite wing 30 and the upper and lower surfaces 52, 60 of the second bite wing 50 may be formed having a smooth surface area, respectively, for the corresponding teeth of the user to engage. In other embodiments of the present invention, the upper and/or lower surfaces 32, 40, 52, 60, of the first and second bite wings 30, 50, respectively, may be formed comprising a surface area, respectively, formed in such a manner to reduce slippage of the engaging teeth when the mouthpiece is inserted into the mouth of the user. For example, and not by way of limitation, the surface areas of the upper and lower surfaces 32, 40, 52, 60 of the first and second bite wings 30, 50, respectively, may be formed having a roughened surface area or a surface area including one or more raised nodules, both being sufficient for the teeth to engage, thereby reducing slippage of the engaging teeth when the mouthpiece 10 is inserted and retained within the mouth of the user.

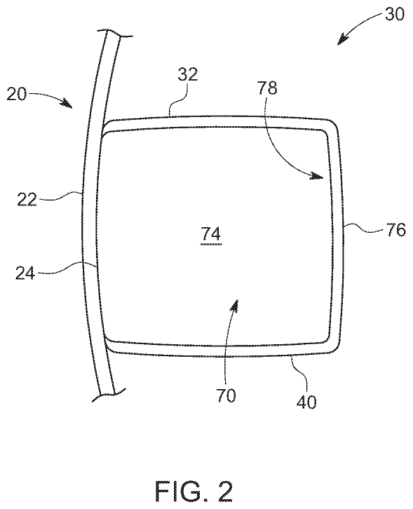

As best shown in FIG. 2, integrally formed between the upper surface 32 and the opposing lower surface 40 of the first bite wing 30 is an internal receiving chamber 70 having a periphery configured for receiving an amount of a fluid or gel. In one embodiment of the present invention, the internal receiving chamber 70 may be defined by the upper and lower surfaces 32, 40 of the first bite wing 30 correspondingly providing an upper wall and a lower opposing wall, together with a front wall 72 and a back wall 74, and a side wall 76 formed opposite the inner surface 24 of the flanged wall 20. In design, the internal receiving chamber 70 formed in the first bite wing 30 includes a selectively sealable fluid receiving opening 80 formed within the front wall 72, wherein the fluid receiving opening 80 may be configured for selectively receiving therethrough an amount of fresh water, a diluted mouthwash, or a flavored fluid or gel introduced into the internal periphery of the receiving chamber 70 upon introduction of a leading end of a delivery member (not shown), such as, for example but not by way of limitation, a syringe, containing a supply of the fresh water, diluted mouthwash, or flavored fluid or gel. Upon removal of the leading end of the delivery member after introducing the fluid or gel into the internal periphery of the receiving chamber 70, the fluid receiving opening 80 formed within the front wall 72 of the receiving chamber 70 selectively reseals the internal periphery of the receiving chamber thereby providing means for retaining the amount of fluid or gel introduced into the internal receiving chamber 70 of the first bite wing 30.

Similar in configuration to the first bite wing 30, integrally formed between the upper surface 52 and the opposing lower surface 60 of the second bite wing 50 is an internal receiving chamber 70 having a periphery configured for receiving an amount of a flavored fluid or gel. In one embodiment of the present invention, the internal receiving chamber 70 may be defined by the upper and lower surfaces 52, 60 of the second bite wing 50 correspondingly providing an upper wall and a lower opposing wall, together with a front wall 72 and a back wall 74, and a side wall 76 formed opposite the inner surface 24 of the flanged wall 20. In design, the internal receiving chamber 70 formed in the second bite wing 50 includes a selectively sealable fluid receiving opening 80 formed within the front wall 72, wherein the fluid receiving opening 80 may be configured for selectively receiving therethrough an amount of the fluid or gel introduced into the internal periphery of the receiving chamber 70 upon introduction of a leading end of a delivery member (not shown), such as, for example but not by way of limitation, a syringe, containing a supply of fresh water, diluted mouthwash, or a flavored fluid or gel. Upon removal of the leading end of the delivery member after introducing the flavored fluid or gel into the internal periphery of the receiving chamber 70, the fluid receiving opening 80 formed within the front wall 72 of the receiving chamber 70 selectively reseals the internal periphery of the receiving chamber thereby providing means for retaining the amount of fluid or gel introduced into the internal receiving chamber 70 of the second bite wing 50.

In order to deliver the fresh water, diluted mouthwash, or flavored fluid or gel contained within the internal receiving chamber 70 of the first bite wing 30 into the mouth of the user, at least one selectively sealable fluid delivery opening 82 may be formed in the side wall 76 of the internal receiving chamber 70 and configured for selectively dispensing the fluid or gel therethrough upon an application of sufficient pressure or force applied by the teeth of the user to the upper and/or lower surfaces 32, 40 of the first bite wing 30. Upon application of pressure or sufficient force on the upper and/or lower surfaces 32, 40 of the first bite wing 30, an amount of the fresh water, diluted mouthwash, or flavored fluid or gel housed within the respective internal receiving chamber 70 will be delivered through one or more selectively sealable fluid delivery openings 82 formed in the corresponding side wall 76 and into the user's mouth. In one embodiment of the present invention, two or more selectively sealable fluid delivery openings 82a, 82b, 82c are formed in the side wall 76 of the internal receiving chamber 70 in the first bite wing 30 in a spaced apart relationship to each other. As appreciated, the amount of fluid or gel that may be dispensed into the mouth of the user through at least one selectively sealable fluid delivery opening 82 will depend on the need of the user to satisfactorily overcome or substantially ameliorate the effects associated with salt mouth that the user is experiencing while snorkeling or SCUBA diving.

Correspondingly, in one embodiment of the present invention, an amount of fresh water, diluted mouthwash, or a flavored fluid or gel may be introduced into an internal receiving chamber 70 formed in the second bite wing 50 of the mouthpiece 10. Whereby, in order to deliver the fluid or gel contained within the internal receiving chamber 70 of the second bite wing 50 into the mouth of the user, at least one selectively sealable fluid delivery opening 82 may be formed in the side wall 76 of the internal receiving chamber 70 and configured for selectively dispensing the fluid or gel therethrough upon an application of sufficient pressure or force applied by the teeth of the user to the upper and/or lower surfaces 52, 60 of the second bite wing 50. Upon application of pressure or sufficient force on the upper and/or lower surfaces 32, 40 of the second bite wing 50, an amount of the fresh water, diluted mouthwash, or flavored fluid or gel housed within the respective internal receiving chamber 70 will be delivered through one or more selectively sealable fluid delivery openings 82 formed in the corresponding side wall 76 and into the user's mouth. In one embodiment of the present invention, two or more selectively sealable fluid delivery openings 82a, 82b, 82c are formed in the side wall 76 of the internal receiving chamber 70 in the second bite wing 50 in a spaced apart relationship to each other. As appreciated, the amount of fluid or gel that may be dispensed into the mouth of the user through at least one selectively sealable fluid delivery opening 82 will depend on the need of the user to satisfactorily overcome or substantially ameliorate the effects associated with salt mouth that the user is experiencing while snorkeling or SCUBA diving.

In some embodiments of the present invention, at least one internal receiving chamber 70 is formed in the first bite wing 30 and at least one internal receiving chamber 70 is formed in the second opposing bite wing 50. The internal receiving chambers are configured in the manner, as described above and as illustrated in FIG. 2, so as to receive and retain an amount of fresh water, diluted mouthwash, or a flavored fluid or gel which may then be selectively delivered from the internal receiving chambers upon an application of a sufficient force to allow an amount of the fluid or gel to flow through one or more of the selectively sealable fluid delivery openings 82 formed in the side wall of each of the receiving chambers 70 formed in the first and second bite wings 30, 40 and into the user's mouth in an amount sufficient to overcome or substantially ameliorate the effects associated with salt mouth.

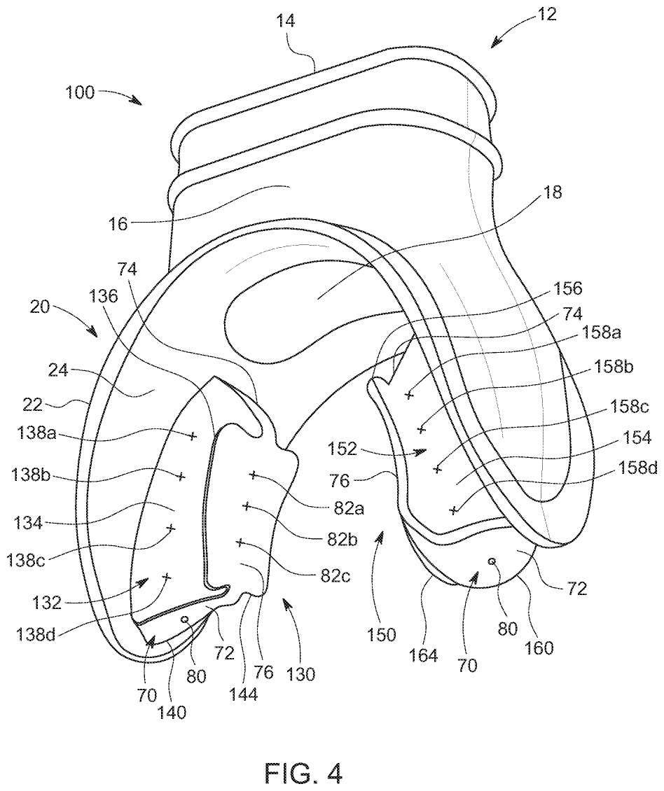

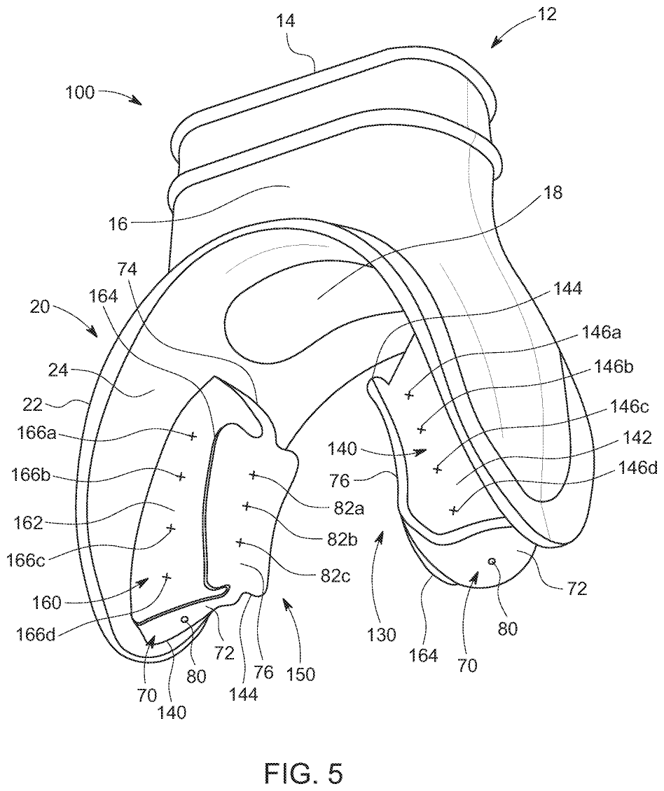

Referring now to FIGS. 4 and 5, an alternative embodiment of a mouthpiece, designated generally as 100, is illustrated. As shown, the mouthpiece 100 includes a first body portion 12 and a contiguous second body portion 16. The first body portion 12 comprises a configuration designed to selectively engage a snorkel 84, as best shown in FIG. 8, or a first and/or second stage SCUBA diving regulator 385, as best shown in FIG. 9.

In one embodiment of the structural design, the mouthpiece 100 comprises an opening 14 formed in the first body portion 12, wherein the opening 14 is configured in a corresponding shape adaptable to provide a sealing engagement with a snorkel or a first and/or second stage SCUBA diving regulator so as to provide an internal conduit 18 sufficient to allow for the passage of air between the snorkel or the first and/or second SCUBA diving regulators and the mouthpiece 100, respectively.

Extending contiguously from the first body portion 12 and the opening 14 formed therein, the mouthpiece 100 comprises a second body portion 16 configured for being selectively introduced into the mouth of a user. In one embodiment of the present invention, the second body portion 16 of the mouthpiece 100 comprises a flanged wall 20 formed in a substantially semi-circular or “U” shaped configuration and defining an outer surface 22 and an inner surface 24, with a thickness defined therebetween. A portion of the internal conduit 18 may be formed along a portion of the length of the inner surface 24 of the flanged wall 20 and configured to engage the opening 14 formed in the first body portion 12 so as allow for the passage of air between the snorkel or the first and/or second SCUBA diving regulators and the mouthpiece 100, respectively. In addition, the second body portion 16 of the mouthpiece 100 may be formed having a first bite wing 130 and a second bite wing 150 formed on opposing sides of the inner surface 24 of the flanged wall 20.

The first bite wing 130 may be configured comprising an upper surface 132 and an opposing lower surface 140, wherein both the upper surface 132 and the lower surface 140 are disposed substantially perpendicular to the inner surface 24 of the flanged wall 20. In one embodiment of the present invention, the upper surface 132 of the first bite wing 130 may be formed having an inwardly extending upward bend at the furthermost width of the upper surface 132 of the first bite wing 130 opposite the inner surface 24 of the flanged wall 20, thereby forming an upper side wall or flange 136. The upper surface 132 of the first bite wing 130 may also be generally configured having a surface area 134 sufficient in size and dimension to engage some of the corresponding upper teeth of the user between the corresponding inner surface 24 of the flanged wall 20 and the upper side wall or flange 136 of the first bite wing 130 therebetween.

Similarly, a second bite wing 150 may be configured comprising an upper surface 152 and an opposing lower surface 160, wherein both the upper surface 152 and the lower surface 160 are disposed substantially perpendicular to the inner surface 24 of the flanged wall 20. In one embodiment of the present invention, the upper surface 152 of the second bite wing 150 may be formed having an inwardly extending upward bend at the furthermost width of the upper surface 152 of the second bite wing 150 opposite the inner surface 24 of the flanged wall 20, thereby forming an upper side wall or flange 156. The upper surface 152 of the second bite wing 150 may also be generally configured having a surface area 154 sufficient in size and dimension to engage some of the corresponding upper teeth of the user between the corresponding inner surface 24 of the flanged wall 20 and the upper side wall or flange 156 of the second bite wing 150 therebetween.

Similar in configuration to the upper surface 132 of the first bite wing 130, the lower surface 140 of the first bite wing 130 may be formed having an inwardly extending downward bend at the furthermost width of the lower surface 140 opposite the inner surface 24 of the flanged wall 20, thereby forming a lower side wall or flange 144. The lower surface 140 of the first bite wing 130 may also be generally configured having a surface area 142 sufficient in size and dimension to engage some of the corresponding lower teeth of the user between the corresponding inner surface 24 of the flanged wall 20 and the lower side wall or flange 144 of the first bite wing 130 therebetween.

In one embodiment, the lower surface 160 of the second bite wing 150 may be formed having an inwardly extending downward bend at the furthermost width of the lower surface 140 opposite the inner surface 24 of the flanged wall 20, thereby forming a lower side wall or flange 164. The lower surface 160 of the second bite wing 150 may also be generally configured having a surface area 162 sufficient in size and dimension to engage some of the corresponding lower teeth of the user between the corresponding inner surface 24 of the flanged wall 20 and the lower side wall or flange 164 of the second bite wing 150 therebetween.

In one embodiment of the present invention, the upper and lower surfaces 132, 140 of the first bite wing 130 and the upper and lower surfaces 152, 160 of the second bite wing 50, respectively, may be formed having a smooth surface area, respectively, for the corresponding teeth of the user to engage. In other embodiments of the present invention, the upper and/or lower surfaces 132, 140, 152, 160, of the first and second bite wings 130, 150, respectively, may be formed comprising a surface area, respectively, formed in such a manner to reduce slippage of the engaging teeth when the mouthpiece is inserted into the mouth of the user. For example, and not by way of limitation, the surface areas of the upper and lower surfaces 132, 140, 152, 160 of the first and second bite wings 130, 150, respectively, may be formed having a roughened surface area or a surface area including one or more raised nodules, both being sufficient for the teeth to engage, thereby reducing slippage of the engaging teeth when the mouthpiece 100 is inserted and retained within the mouth of the user.

Integrally formed between the upper surface 132 and the opposing lower surface 140 of the first bite wing 130 is an internal receiving chamber 70 having a periphery configured for receiving an amount of fresh water, diluted mouthwash, or a flavored fluid or gel. In one embodiment of the present invention, the internal receiving chamber 70 may be defined by the upper and lower surfaces 132, 140 of the first bite wing 130 correspondingly providing an upper wall and a lower opposing wall, together with a front wall 72 and a back wall 74, and a side wall 76 formed opposite the inner surface 24 of the flanged wall 20, as shown by comparison in FIG. 2. In structural design, the internal receiving chamber 70 formed in the first bite wing 130 includes a selectively sealable fluid receiving opening 80 formed within the front wall 72, wherein the fluid receiving opening 80 may be configured for selectively receiving therethrough an amount of the fluid or gel introduced into the internal periphery of the receiving chamber 70 upon introduction of a leading end of a delivery member (not shown), such as, for example but not by way of limitation, a syringe, containing a supply of the fluid or gel. Upon removal of the leading end of the delivery member after introducing the fresh water, diluted mouthwash, or flavored fluid or gel into the internal periphery of the receiving chamber 70, the fluid receiving opening 80 formed within the front wall 72 of the receiving chamber 70 selectively reseals the internal periphery of the receiving chamber thereby providing means for retaining the amount of fluid or gel introduced into the internal receiving chamber 70 of the first bite wing 130 of the mouthpiece 100.

Similar in configuration to the first bite wing 130, integrally formed between the upper surface 152 and the opposing lower surface 160 of the second bite wing 150 is an internal receiving chamber 70 having a periphery configured for receiving an amount of a fresh water, diluted mouthwash, or a flavored fluid or gel. In one embodiment of the present invention, the internal receiving chamber 70 may be defined by the upper and lower surfaces 152, 160 of the second bite wing 150 correspondingly providing an upper wall and a lower opposing wall, together with a front wall 72 and a back wall 74, and a side wall 76 formed opposite the inner surface 24 of the flanged wall 20, as shown by comparison in FIG. 2. In structural design, the internal receiving chamber 70 formed in the second bite wing 150 includes a selectively sealable fluid receiving opening 80 formed within the front wall 72, wherein the fluid receiving opening 80 may be configured for selectively receiving therethrough an amount of the fluid or gel introduced into the internal periphery of the receiving chamber 70 upon introduction of a leading end of a delivery member (not shown), such as, for example but not by way of limitation, a syringe, containing a supply of the fluid or gel. Upon removal of the leading end of the delivery member after introducing the fresh water, diluted mouthwash, or flavored fluid or gel into the internal periphery of the receiving chamber 70, the fluid receiving opening 80 formed within the front wall 72 of the receiving chamber 70 selectively reseals the internal periphery of the receiving chamber thereby providing means for retaining the amount of the fluid or gel introduced into the internal receiving chamber 70 of the second bite wing 150 of the mouthpiece 100.

In order to deliver the fluid or gel contained within the internal receiving chamber 70 of the first bite wing 130 into the mouth of the user, at least one selectively sealable fluid delivery opening 82 may be formed in the side wall 76 of the internal receiving chamber 70 and configured for selectively dispensing the fresh water, diluted mouthwash, or flavored fluid or gel therethrough upon an application of sufficient pressure or force applied by the teeth of the user to the upper and/or lower surfaces 132, 140 of the first bite wing 130. Upon application of pressure or sufficient force on the upper and/or lower surfaces 132, 140 of the first bite wing 130, an amount of the fluid or gel housed within the respective internal receiving chamber 70 will be delivered through one or more selectively sealable fluid delivery openings 82 formed in the corresponding side wall 76 and into the user's mouth. In one embodiment of the present invention, two or more selectively sealable fluid delivery openings 82a, 82b, 82c are formed in the side wall 76 of the internal receiving chamber 70 in the first bite wing 130 in a spaced apart relationship to each other.

In addition to the one or more selectively sealable fluid delivery openings 82 formed in the side wall 76 of the internal receiving chamber 70 formed in the first bite wing 150, in one embodiment of the present invention, at least one selectively sealable fluid delivery opening 138 may be formed in at least a portion of the surface area 134 of the upper surface 132 of the first bite wing 130. As shown in FIG. 4, at least two selectively sealable fluid delivery openings 138a, 138b, 138c, 138d are formed in the surface area 134 of the upper surface 132 in a spaced apart relationship to each other. As appreciated, the amount of fresh water, diluted mouthwash, or flavored fluid or gel that may be dispensed into the mouth of the user through at least one selectively sealable fluid delivery opening 82 formed in the side wall 76 of the internal receiving chamber 70 and at least one selectively sealable fluid delivery opening 138 formed in the upper surface 132 of the first bite wing 130 will depend on the need of the user to satisfactorily overcome or substantially ameliorate the effects associated with salt mouth that the user is experiencing while snorkeling or SCUBA diving.

Additionally, in one embodiment of the present invention, at least two selectively sealable fluid delivery openings 158a, 158b, 158c, 158d are formed in the surface area 154 of the upper surface 152 of the second bite wing 150 in a spaced apart relationship to each other. As appreciated, the amount of fluid or gel that may be dispensed into the mouth of the user through at least one selectively sealable fluid delivery opening 82 formed in the side wall 76 of the internal receiving chamber 70 and at least one selectively sealable fluid delivery opening 158 formed in the upper surface 152 of the second bite wing 150 will depend on the need of the user to satisfactorily overcome or substantially ameliorate the effects associated with salt mouth that the user is experiencing while snorkeling or SCUBA diving. Upon application of pressure or sufficient force on the upper and/or lower surfaces 132, 140 of the second bite wing 150, an amount of the fresh water, diluted mouthwash, or flavored fluid or gel housed within the respective internal receiving chamber 70 will be delivered through one or more selectively sealable fluid delivery openings 82 formed in the corresponding side wall 76 and into the user's mouth. In one embodiment of the present invention, two or more selectively sealable fluid delivery openings 82a, 82b, 82c are formed in the side wall 76 of the internal receiving chamber 70 in the second bite wing 150 in a spaced apart relationship to each other.

One embodiment of the present invention contemplates that in addition to the one or more selectively sealable fluid delivery openings 82a, 82b, 82c formed in the side wall 76 of the internal receiving chamber 70 formed in the first and/or second bite wings 130, 150, the selectively sealable fluid delivery openings 138a, 138b, 138c, 138d formed in the surface area 134 of the upper surface 132 of the first bite wing 130 and the selectively sealable fluid delivery openings 158a, 158b, 158c, 158d formed in the upper surface 152 of the second bite wing, one or more selectively sealable fluid delivery openings 146a, 146b, 146c, 146d may be formed in a spaced apart relationship in at least a portion of the surface area 142 of the lower surface 140 of the first bite wing 130 and one or more selectively sealable fluid delivery openings 166a, 166b, 166c, 166d may be formed in a spaced apart relationship in at least a portion of the surface area 162 of the lower surface 160 of the second bite wing 150. Thus, in accordance with such an embodiment of the present invention, upon application of pressure or sufficient force on the upper surfaces 132, 152 and/or the lower surfaces 140, 160 of the first and/or second bite wings 130, 150, respectively, an amount of the fresh water, diluted mouthwash, or flavored fluid or gel contained within the respective internal receiving chamber 70 will be delivered through one or more selectively sealable fluid delivery openings 82 formed in the corresponding side wall 76 and through one or more selectively sealable fluid delivery openings 138, 158 formed in the upper surface and/or through one or more selectively sealable fluid delivery openings 146, 166 formed in the lower surface of the first and/or second bite wings 130, 150 and into the user's mouth.

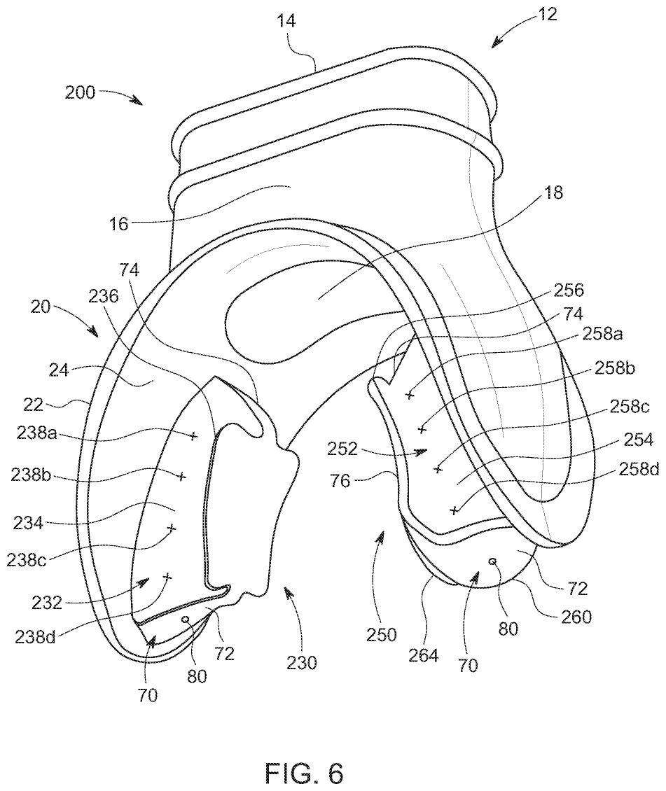

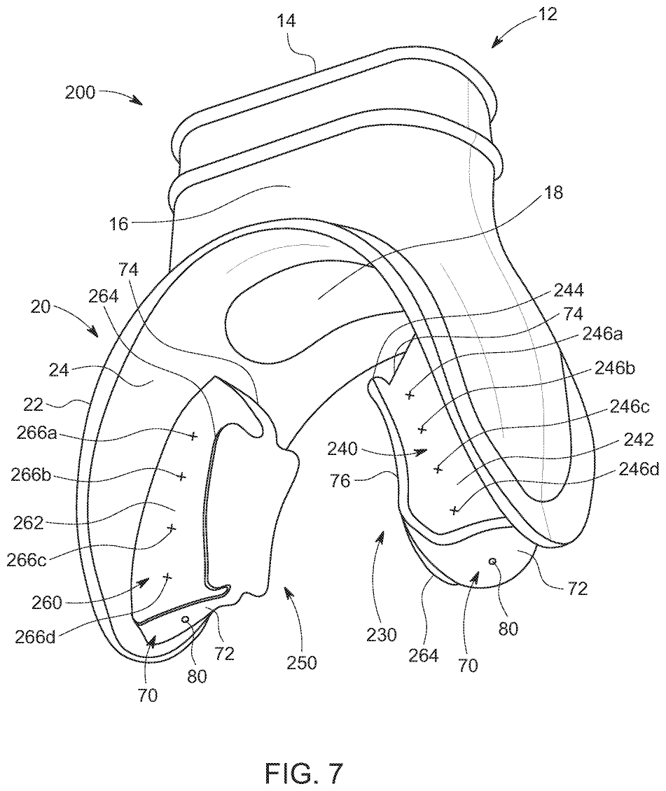

Referring now to FIGS. 6 and 7, another embodiment of a mouthpiece of the present invention, designated generally as 200, is illustrated. As shown, the mouthpiece 200 includes a first body portion 12 and a contiguous second body portion 16. The first body portion 12 comprises a configuration designed to selectively engage a snorkel 84, as best shown in FIG. 8, or a first and/or second stage SCUBA diving regulator 385, as best shown in FIG. 9.

In one embodiment, the structural design of the mouthpiece 200 comprises an opening 14 formed in the first body portion 12, wherein the opening 14 is configured in a corresponding shape adaptable to provide a sealing engagement with a snorkel or a first and/or second stage SCUBA diving regulator so as to provide an internal conduit 18 sufficient to allow for the passage of air between the snorkel or the first and/or second SCUBA diving regulators and the mouthpiece 200, respectively.

Extending contiguously from the first body portion 12 and the opening 14 formed therein, the mouthpiece 200 comprises a second body portion 16 configured for being selectively introduced into the mouth of a user. In one embodiment of the present invention, the second body portion 16 of the mouthpiece 200 comprises a flanged wall 20 formed in a substantially semi-circular or “U” shaped configuration and defining an outer surface 22 and an inner surface 24, with a thickness defined therebetween. A portion of the internal conduit 18 may be formed along a portion of the length of the inner surface 24 of the flanged wall 20 and configured to engage the opening 14 formed in the first body portion 12 so as allow for the passage of air between the snorkel or the first and/or second SCUBA diving regulators and the mouthpiece 100, respectively. In addition, the second body portion 16 of the mouthpiece 200 may be formed having a first bite wing 230 and a second bite wing 250 formed on opposing sides of the inner surface 24 of the flanged wall 20.

The first bite wing 230 may be configured comprising an upper surface 232 and an opposing lower surface 240, wherein both the upper surface 232 and the lower surface 240 are disposed substantially perpendicular to the inner surface 24 of the flanged wall 20. In one embodiment of the present invention as shown in FIG. 6, the upper surface 232 of the first bite wing 230 may be formed having an inwardly extending upward bend at the furthermost width of the upper surface 232 of the first bite wing 230 opposite the inner surface 24 of the flanged wall 20, thereby forming an upper side wall or flange 236. The upper surface 232 of the first bite wing 230 may also be generally configured having a surface area 234 sufficient in size and dimension to engage some of the corresponding upper teeth of the user between the inner surface 24 of the flanged wall 20 and the upper side wall or flange 236 of the first bite wing 230 therebetween.

Similarly, a second bite wing 250 may be configured comprising an upper surface 252 and an opposing lower surface 260, wherein both the upper surface 252 and the lower surface 260 are disposed substantially perpendicular to the inner surface 24 of the flanged wall 20. In one embodiment of the present invention, the upper surface 252 of the second bite wing 250 may be formed having an inwardly extending upward bend at the furthermost width of the upper surface 252 of the second bite wing 250 opposite the inner surface 24 of the flanged wall 20, thereby forming an upper side wall or flange 256. The upper surface 252 of the second bite wing 250 may also be generally configured having a surface area 254 sufficient in size and dimension to engage some of the corresponding upper teeth of the user between the inner surface 24 of the flanged wall 20 and the upper side wall or flange 256 of the second bite wing 250 therebetween.

Similar in configuration to the upper surface 232 of the first bite wing 230, the lower surface 240 of the first bite wing 230 may be formed having an inwardly extending downward bend at the furthermost width of the lower surface 240 opposite the inner surface 24 of the flanged wall 20, thereby forming a lower side wall or flange 244, as best shown in FIG. 7. The lower surface 240 of the first bite wing 230 may also be generally configured having a surface area 242 sufficient in size and dimension to engage some of the corresponding lower teeth of the user between the inner surface 24 of the flanged wall 20 and the lower side wall or flange 244 of the first bite wing 230 therebetween.

In one embodiment of the present invention, the lower surface 260 of the second bite wing 250 may be formed having an inwardly extending downward bend at the furthermost width of the lower surface 240 opposite the inner surface 24 of the flanged wall 20, thereby forming a lower side wall or flange 264. The lower surface 260 of the second bite wing 250 may also be generally configured having a surface area 262 sufficient in size and dimension to engage some of the corresponding lower teeth of the user between the inner surface 24 of the flanged wall 20 and the lower side wall or flange 264 of the second bite wing 250 therebetween.

The upper and lower surfaces 232, 240 of the first bite wing 230 and the upper and lower surfaces 252, 260 of the second bite wing 250 may be formed having a smooth surface area, respectively, for the corresponding teeth of the user to engage. In other embodiments of the present invention, the upper and/or lower surfaces 232, 240, 252, 260, of the first and second bite wings 230, 250, respectively, may be formed comprising a surface area, respectively, formed in such a manner to reduce slippage of the engaging teeth when the mouthpiece is inserted into the mouth of the user. For example, and not by way of limitation, the surface areas of the upper and lower surfaces 232, 240, 252, 260 of the first and second bite wings 230, 250, respectively, may be formed having a roughened surface area or a surface area including one or more raised nodules, both being sufficient for the teeth to engage, thereby reducing slippage of the engaging teeth when the mouthpiece 200 is inserted and retained within the mouth of the user.

Integrally formed between the upper surface 232 and the opposing lower surface 240 of the first bite wing 230 is an internal receiving chamber 70 having a periphery configured for receiving an amount of fresh water, diluted mouthwash, or a flavored fluid or gel. In one embodiment of the present invention, the internal receiving chamber 70 may be defined by the upper and lower surfaces 232, 240 of the first bite wing 230 correspondingly providing an upper wall and a lower opposing wall, together with a front wall 72 and a back wall 74, and a side wall 76 formed opposite the inner surface 24 of the flanged wall 20, as shown by comparison in FIG. 2.

In structural design, the internal receiving chamber 70 formed in the first bite wing 230 includes a selectively sealable fluid receiving opening 80 formed within the front wall 72, wherein the fluid receiving opening 80 may be configured for selectively receiving therethrough an amount of the fluid or gel introduced into the internal periphery of the receiving chamber 70 upon introduction of a leading end of a delivery member (not shown), such as, for example but not by way of limitation, a syringe, containing a supply of the fresh water, diluted mouthwash, or flavored fluid or gel. Upon removal of the leading end of the delivery member after introducing the fluid or gel into the internal periphery of the receiving chamber 70, the fluid receiving opening 80 formed within the front wall 72 of the receiving chamber 70 selectively reseals the internal periphery of the receiving chamber thereby providing means for retaining the amount of fresh water, diluted mouthwash, or flavored fluid or gel introduced into the internal receiving chamber 70 of the first bite wing 230 of the mouthpiece 200.

Similar in configuration to the first bite wing 230, integrally formed between the upper surface 252 and the opposing lower surface 260 of the second bite wing 250 is an internal receiving chamber 70 having a periphery configured for receiving an amount of a fresh water, diluted mouthwash, or a flavored fluid or gel. In one embodiment of the present invention, the internal receiving chamber 70 may be defined by the upper and lower surfaces 252, 260 of the second bite wing 250 correspondingly providing an upper wall and a lower opposing wall, together with a front wall 72 and a back wall 74, and a side wall 76 formed opposite the inner surface 24 of the flanged wall 20, as shown by comparison in FIG. 2. In structural design, the internal receiving chamber 70 formed in the second bite wing 250 includes a selectively sealable fluid receiving opening 80 formed within the front wall 72, wherein the fluid receiving opening 80 may be configured for selectively receiving therethrough an amount of fresh water, diluted mouthwash, or flavored fluid or gel introduced into the internal periphery of the receiving chamber 70 upon introduction of a leading end of a delivery member (not shown), such as, for example but not by way of limitation, a syringe, containing a supply of the fluid or gel. Upon removal of the leading end of the delivery member after introducing the fluid or gel into the internal periphery of the receiving chamber 70, the fluid receiving opening 80 formed within the front wall 72 of the receiving chamber 70 selectively reseals the internal periphery of the receiving chamber thereby providing means for retaining the amount of the fresh water, diluted mouthwash, or flavored fluid or gel introduced into the internal receiving chamber 70 of the second bite wing 250 of the mouthpiece 200.

In order to deliver the fluid or gel contained within the internal receiving in one embodiment of the present invention, at least one selectively sealable fluid delivery opening 238 may be formed in at least a portion of the surface area 234 of the upper surface 232 of the first bite wing 230. As shown in FIG. 6, at least two selectively sealable fluid delivery openings 238a, 238b, 238c, 238d are formed in the surface area 234 of the upper surface 232 in a spaced apart relationship to each other. As appreciated, the amount of fresh water, diluted mouthwash, or flavored fluid or gel that may be dispensed into the mouth of the user through at least one selectively sealable fluid delivery opening 238 formed in the upper surface 232 of the first bite wing 230 will depend on the need of the user to satisfactorily overcome or substantially ameliorate the effects associated with salt mouth that the user is experiencing while snorkeling or SCUBA diving.

Additionally, in one embodiment of the present invention, at least one selectively sealable fluid delivery opening 258 may be formed in at least a portion of the surface area 254 of the upper surface 252 of the second bite wing 250. As shown in FIG. 6, at least two selectively sealable fluid delivery openings 238a, 238b, 238c, 238d may be formed in the surface area 234 of the upper surface 232 in a spaced apart relationship to each other. As appreciated, the amount of fresh water, diluted mouthwash, or flavored fluid or gel that may be dispensed into the mouth of the user through at least one selectively sealable fluid delivery opening 258 formed in the upper surface 252 of the second bite wing 250 will depend on the need of the user to satisfactorily overcome or substantially ameliorate the effects associated with salt mouth that the user is experiencing while snorkeling or SCUBA diving. Upon application of pressure or sufficient force on the upper and/or lower surfaces 232, 240 of the second bite wing 250, an amount of the fluid or gel housed within the respective internal receiving chamber 70 will be delivered through one or more selectively sealable fluid delivery openings 238, 258 formed in the upper surfaces 232, 252 of the corresponding first and second bite wings 230, 250, respectively, and into the user's mouth.

As best shown in FIG. 7, one embodiment of the present invention contemplates that in addition to the one or more selectively sealable fluid delivery openings 238 formed in the surface area 234 of the upper surface 232 of the first bite wing 230 and the selectively sealable fluid delivery openings 258 formed in the upper surface 252 of the second bite wing 250, one or more selectively sealable fluid delivery openings 246 may be formed in a spaced apart relationship in at least a portion of the surface area 242 of the lower surface 240 of the first bite wing 230 and one or more selectively sealable fluid delivery openings 266 may be formed in a spaced apart relationship in at least a portion of the surface area 262 of the lower surface 260 of the second bite wing 250. Thus, in accordance with such an embodiment of the present invention, upon application of pressure or sufficient force on the upper surfaces 232, 252 and/or the lower surfaces 240, 260 of the first and/or second bite wings 230, 250, respectively, an amount of the fresh water, diluted mouthwash, or flavored fluid or gel contained within the respective internal receiving chamber 70 will be delivered through one or more selectively sealable fluid delivery openings 238, 258 formed in the upper surface and/or through one or more selectively sealable fluid delivery openings 246, 266 formed in the lower surface of the first and/or second bite wings 230, 250, respectively, and into the user's mouth.

As previously presented, FIG. 8 shows a snorkel 84 having a mouthpiece 10 of the present invention selectively attached thereto. As appreciated by those skilled in the art, a mouthpiece generally comes with a snorkel 84 when purchasing standard equipment. However, a mouthpiece may also be removable from a snorkel and replaced when it becomes distorted or uncomfortable, if desired. To this end, the embodiments of the mouthpieces 10, 100, 200 of the present invention, as shown in FIGS. 1-7, are configured at the first body portion 12 to selectively engage a snorkel 84 as an original mouthpiece or as a replacement mouthpiece. Thus, should a user of a snorkel desire to replace a standard mouthpiece with a mouthpiece of the present invention having the capability to store and deliver an amount of flavored fluid or gel into the user's mouth sufficient to overcome or substantially ameliorate the effects associated with salt mouth, the design of the mouthpieces of the present invention may be used to selectively engage the snorkel of the user. To this end, the engagement of a mouthpiece of the present invention provides an internal conduit 18 sufficient to allow for the passage of air between the snorkel 84 and the mouthpiece 10.

Likewise, FIG. 9 shows a first and/or second stage SCUBA diving regulator having an alternative embodiment of a mouthpiece 300 of the present invention selectively attached thereto. As appreciated by those skilled in the art, a mouthpiece generally comes with a first and/or second stage SCUBA diving regulator when purchasing standard equipment. However, the mouthpiece may also be removable from engagement with a first and/or second stage SCUBA diving regulator and replaced when it becomes distorted or uncomfortable, if desired. To this end, the embodiments of the mouthpieces 10, 100, 200, 300 of the present invention, as also shown in FIGS. 1-7, are configured at the first body portion 12 to selectively engage a first and/or second stage SCUBA diving regulator as original equipment or as a replacement mouthpiece. Thus, should a user of a first and/or second stage SCUBA diving regulator desire to replace a standard mouthpiece with a mouthpiece of the present invention having the capability to store and deliver an amount of flavored fluid or gel into the user's mouth sufficient to overcome or substantially ameliorate the effects associated with salt mouth, the design of the mouthpieces of the present invention may be used to selectively engage a first and/or second stage SCUBA diving regulator of the user. To this end, the engagement of a mouthpiece of the present invention provides an internal conduit 18 sufficient to allow for the passage of air between the first and/or second SCUBA diving regulators and the mouthpiece 10.

Still referring to FIG. 9, an alternate embodiment of a mouthpiece, designated generally as 300, is illustrated. As shown, the mouthpiece 300 includes a first body portion 12 and a contiguous second body portion 16. The first body portion 12 comprises a configuration designed to selectively engage a first and/or second stage SCUBA diving regulator 385.

In one embodiment of the present invention, the mouthpiece 300 comprises an opening 14 formed in the first body portion 12, wherein the opening 14 is configured in a corresponding shape adaptable to provide a sealing engagement with a first and/or second stage SCUBA diving regulator 385 so as to provide an internal conduit 18 sufficient to allow for the passage of air between the first and/or second SCUBA diving regulator 385 and the mouthpiece 300, respectively.

Extending contiguously from the first body portion 12 and the opening 14 formed therein, the mouthpiece 300 comprises a second body portion 16 configured for being selectively introduced into the mouth of a user. In one embodiment of the present invention, the second body portion 16 of the mouthpiece 300 comprises a flanged wall 20 formed in a substantially semi-circular or “U” shaped configuration and defining an outer surface 22 and an inner surface 24, with a thickness defined therebetween. A portion of the internal conduit 18 may be formed along a portion of the length of the inner surface 24 of the flanged wall 20 and configured to engage the opening 14 formed in the first body portion 12 so as allow for the passage of air between the first and/or second SCUBA diving regulator 385 and the mouthpiece 300, respectively. In addition, the second body portion 16 of the mouthpiece 300 may be formed having a first bite wing 330 and a second bite wing 350 formed on opposing sides of the inner surface 24 of the flanged wall 20.

The first bite wing 330 may be configured comprising an upper surface 332 and an opposing lower surface (not shown), wherein both the upper surface 332 and the lower surface are disposed substantially perpendicular to the inner surface 24 of the flanged wall 20. In one embodiment of the present invention, the upper surface 332 of the first bite wing 330 may be formed having an inwardly extending upward bend at the furthermost width of the upper surface 332 of the first bite wing 330 opposite the inner surface 24 of the flanged wall 20, thereby forming an upper side wall or flange 336. The upper surface 332 of the first bite wing 330 may also be generally configured having a surface area 334 sufficient in size and dimension to engage some of the corresponding upper teeth of the user between the inner surface 24 of the flanged wall 20 and the upper side wall or flange 336 of the bite wing 330 therebetween.

Similarly, the second bite wing 350 may be configured comprising an upper surface 352 and an opposing lower surface (not shown), wherein both the upper surface 352 and the lower surface are disposed substantially perpendicular to the inner surface 24 of the flanged wall 20. In one embodiment of the present invention, the upper surface 352 of the second bite wing 350 may be formed having an inwardly extending upward bend at the furthermost width of the upper surface 352 of the second bite wing 350 opposite the inner surface 24 of the flanged wall 20, thereby forming an upper side wall or flange 356. The upper surface 352 of the second bite wing 350 may also be generally configured having a surface area 354 sufficient in size and dimension to engage some of the corresponding upper teeth of the user between the inner surface 24 of the flanged wall 20 and the upper side wall or flange 356 of the bite wing 350 therebetween.

Similar in configuration to the upper surface 332 of the first bite wing 330, the lower surface of the first bite wing 330 may be formed having an inwardly extending downward bend at the furthermost width of the lower surface opposite the inner surface 24 of the flanged wall 20, thereby forming a lower side wall or flange. The lower surface of the first bite wing 330 may also be generally configured having a surface area sufficient in size and dimension to engage some of the corresponding lower teeth of the user between the inner surface 24 of the flanged wall 20 and the lower side wall or flange of the first bite wing 330 therebetween.

Similar in configuration to the lower surface of the first bite wing 330, the lower surface of the second bite wing 350 may be formed having an inwardly extending downward bend at the furthermost width of the lower surface opposite the inner surface 24 of the flanged wall 20, thereby forming a lower side wall or flange. The lower surface of the second bite wing 350 may also be generally configured having a surface area sufficient in size and dimension to engage some of the corresponding lower teeth of the user between the inner surface 24 of the flanged wall 20 and the lower side wall or flange of the second bite wing 350 therebetween.

In one embodiment of the present invention, the upper and lower surfaces 332, 340 of the first bite wing 330 and the upper and lower surfaces 352, 360 of the second bite wing 350 may be formed having one or more raised nodules 386 for being engaged by the corresponding teeth of the user, thereby reducing slippage of the teeth in relation to the mouthpiece 300 when inserted and retained within the mouth of the user. For example and not by way of limitation, two or more raised nodules 386 may be configured in the upper and/or lower surfaces 332, 340, 352, 360 of the first and second bite wings 330, 350, respectively. Additionally, the raised nodules 386 formed in the upper and/or lower surfaces of the first and second bite wings 330, 350 comprise at least one selectively sealable fluid delivery opening 388, whereby functioning to allow an amount of the fresh water, diluted mouthwash, or flavored fluid or gel to flow from the internal periphery of the corresponding receiving chamber 70 into the mouth of the user upon application of sufficient pressure or force applied by the teeth of the user. In one presently preferred embodiment, a plurality of raised nodules are formed in the upper and/or lower surfaces of the first and second bite wings 330, 350, whereby providing a comparable number of selectively sealable fluid delivery openings 388.

Integrally formed between the upper surface 332 and the opposing lower surface 340 of the first bite wing 330 is an internal receiving chamber 70 having a periphery configured for receiving an amount of fresh water, diluted mouthwash, or a flavored fluid or gel, as comparably shown in FIG. 2. As in other embodiments of the present invention shown in FIGS. 1-7, the mouthpiece 300 comprises an internal receiving chamber 70 defined by the upper and lower surfaces 332, 340 of the first bite wing 330 correspondingly providing an upper wall and a lower opposing wall, together with a front wall 72 and a back wall 74, and a side wall 76 formed opposite the inner surface 24 of the flanged wall 20. In design, the internal receiving chamber 70 formed in the first bite wing 330 includes a selectively sealable fluid receiving opening 80 formed within the front wall 72, wherein the fluid receiving opening 80 may be configured for selectively receiving therethrough an amount of the fluid or gel introduced into the internal periphery of the receiving chamber 70 upon introduction of a leading end of a delivery member (not shown), such as, for example but not by way of limitation, a syringe, containing a supply of the fresh water, diluted mouthwash, or flavored fluid or gel. Upon removal of the leading end of the delivery member after introducing the flavored fluid or gel into the internal periphery of the receiving chamber 70, the fluid receiving opening 80 formed within the front wall 72 of the receiving chamber 70 selectively reseals the internal periphery of the receiving chamber thereby providing means for retaining the amount of fluid or gel introduced into the internal receiving chamber 70 of the first bite wing 330.

Similar in configuration to the first bite wing 330, integrally formed between the upper surface 352 and the opposing lower surface 360 of the second bite wing 350 is an internal receiving chamber 70 having a periphery configured for receiving an amount of fluid or gel. As in other embodiments of the present invention as shown in FIGS. 1-7, the internal receiving chamber 70 may be defined by the upper and lower surfaces 352, 360 of the second bite wing 350 correspondingly providing an upper wall and a lower opposing wall, together with a front wall 72 and a back wall 74, and a side wall 76 formed opposite the inner surface 24 of the flanged wall 20. In design, the internal receiving chamber 70 formed in the second bite wing 350 includes a selectively sealable fluid receiving opening 80 formed within the front wall 72, wherein the fluid receiving opening 80 may be configured for selectively receiving therethrough an amount of fresh water, diluted mouthwash, or a flavored fluid or gel introduced into the internal periphery of the receiving chamber 70 upon introduction of a leading end of a delivery member (not shown), such as, for example but not by way of limitation, a syringe, containing a supply of the fluid or gel. Upon removal of the leading end of the delivery member after introducing the fresh water, diluted mouthwash, or flavored fluid or gel into the internal periphery of the receiving chamber 70, the fluid receiving opening 80 formed within the front wall 72 of the receiving chamber 70 selectively reseals the internal periphery of the receiving chamber thereby providing means for retaining the amount of fluid or gel introduced into the internal receiving chamber 70 of the second bite wing 350.

In order to deliver the fresh water, diluted mouthwash, or flavored fluid or gel contained within the internal receiving chamber 70 of the first bite wing 330 into the mouth of the user, at least one selectively sealable fluid delivery opening 82 may be formed in the side wall 76 of the internal receiving chamber 70 and configured for selectively dispensing the fluid or gel therethrough upon application of sufficient pressure or force applied by the teeth of the user to the upper and/or lower surfaces 332, 340 of the first bite wing 330. Upon application of pressure or sufficient force on the upper and/or lower surfaces 332, 340 of the first bite wing 330, an amount of the fresh water, diluted mouthwash, or flavored fluid or gel housed within the respective internal receiving chamber 70 will be delivered through one or more selectively sealable fluid delivery openings 82 formed in the corresponding side wall 76 and into the user's mouth. In one embodiment of the present invention, two or more selectively sealable fluid delivery openings 82a, 82b, 82c are formed in the side wall 76 of the internal receiving chamber 70 in the first bite wing 330 in a spaced apart relationship to each other. As appreciated, the amount of fresh water, diluted mouthwash, or flavored fluid or gel that may be dispensed into the mouth of the user through at least one selectively sealable fluid delivery opening 82 will depend on the need of the user to satisfactorily overcome or substantially ameliorate the effects associated with salt mouth that the user is experiencing while snorkeling or SCUBA diving.

Correspondingly, an amount of fresh water, diluted mouthwash, or flavored fluid or gel may be introduced into an internal receiving chamber 70 formed in the second bite wing 350 of the mouthpiece 300. Whereby, in order to deliver the fluid or gel contained within the internal receiving chamber 70 of the second bite wing 350 into the mouth of the user, at least one selectively sealable fluid delivery opening 82 may be formed in the side wall 76 of the internal receiving chamber 70 and configured for selectively dispensing the fluid or gel therethrough upon an application of sufficient pressure or force applied by the teeth of the user to the upper and/or lower surfaces 352, 360 of the second bite wing 350. Upon application of pressure or sufficient force on the upper and/or lower surfaces 332, 340 of the second bite wing 350, an amount of the fresh water, diluted mouthwash, or flavored fluid or gel housed within the respective internal receiving chamber 70 will be delivered through one or more selectively sealable fluid delivery openings 82 formed in the corresponding side wall 76 and into the user's mouth. In one embodiment of the present invention, two or more selectively sealable fluid delivery openings 82a, 82b, 82c are formed in the side wall 76 of the internal receiving chamber 70 in the second bite wing 350 in a spaced apart relationship to each other. As appreciated, the amount of fluid or gel that may be dispensed into the mouth of the user through at least one selectively sealable fluid delivery opening 82 will depend on the need of the user to satisfactorily overcome or substantially ameliorate the effects associated with salt mouth that the user is experiencing while snorkeling or SCUBA diving.

In some embodiments of the present invention, at least one internal receiving chamber 70 is formed in the first bite wing 330 and at least one internal receiving chamber 70 is formed in the second opposing bite wing 350. The internal receiving chambers are configured in the manner, as described above and as illustrated in FIG. 2, so as to receive and retain an amount of fresh water, diluted mouthwash, or flavored fluid or gel which may then be selectively delivered from the internal receiving chambers upon an application of a sufficient force to allow an amount of the fluid or gel to flow through one or more of the selectively sealable fluid delivery openings 82 formed in the side wall of each of the receiving chambers 70 formed in the first and second bite wings 330, 340 and into the user's mouth in an amount sufficient to overcome or substantially ameliorate the effects associated with salt mouth.

In another alternate embodiment of the present invention, the mouthpiece may be configured similar to the embodiments illustrated in FIGS. 1-9, however, not having a first body portion comprising a shape adaptable for engaging a snorkel or a first and/or second stage SCUBA diving regulator or an opening defining an internal conduit for the passage of air. In this regard, the present invention contemplates a mouthpiece designed to act as a mouth guard having a configuration that provides protection to the mouth, teeth and gums of the user in an effort to prevent and/or reduce injuries to the teeth, arches, lips and gums.

The mouthpiece or mouth guard, as contemplated herein, may comprises a body portion configured for being selectively introduced into the mouth of a user, wherein the body portion comprises a flanged wall formed in a substantially semi-circular or “U” shaped configuration and defining an outer surface and an inner surface, with a thickness defined therebetween. The body portion may also be formed comprising a single bite wing configured in a substantially semi-circular or “U” shaped configuration similar to the flanged wall or, in the alternative, a first bite wing and a second bite wing formed on opposing sides of the inner surface of the flanged wall.

The first bite wing may be configured comprising an upper surface and an opposing lower surface, wherein both the upper surface and the lower surface are disposed substantially perpendicular to the inner surface of the flanged wall. In one embodiment of the present invention, the upper surface of the first bite wing may be formed having an inwardly extending upward bend at the furthermost width of the upper surface of the first bite wing opposite the inner surface of the flanged wall, thereby forming an upper side wall or flange. The upper surface of the first bite wing may also be generally configured having a surface area sufficient in size and dimension to engage some of the corresponding upper teeth of the user between the corresponding inner surface of the flanged wall and the upper side wall or flange of the first bite wing therebetween.

Similarly, a second bite wing may be configured comprising an upper surface and an opposing lower surface, wherein both the upper surface and the lower surface are disposed substantially perpendicular to the inner surface of the flanged wall. In one embodiment of the present invention, the upper surface of the second bite wing may be formed having an inwardly extending upward bend at the furthermost width of the upper surface of the second bite wing opposite the inner surface of the flanged wall, thereby forming an upper side wall or flange. The upper surface of the second bite wing may also be generally configured having a surface area sufficient in size and dimension to engage some of the corresponding upper teeth of the user between the corresponding inner surface of the flanged wall and the upper side wall or flange of the second bite wing therebetween.

In one embodiment of the present invention, the upper and lower surfaces of the first bite wing and the upper and lower surfaces of the second bite wing, respectively, may be formed having a smooth surface area for the corresponding teeth of the user to engage. In other embodiments of the present invention, the upper and/or lower surfaces of the first and second bite wings, respectively, may be formed comprising a surface area, respectively, formed in such a manner to reduce slippage of the engaging teeth when the mouthpiece is inserted into the mouth of the user. For example, and not by way of limitation, the surface area of the upper surfaces of the first and second bite wings, respectively, may be formed having a roughened surface area or a surface area including one or more raised nodules, both being sufficient for the teeth to engage, thereby reducing slippage of the engaging teeth when the mouthpiece is inserted and retained within the mouth of the user.

Integrally formed between the upper surface and the opposing lower surface of the first bite wing is an internal receiving chamber having a periphery configured for receiving an amount of fresh water, diluted mouthwash, or a flavored fluid or gel. In one embodiment of the present invention, the internal receiving chamber may be defined by the upper and lower surfaces of the first bite wing correspondingly providing an upper wall and a lower opposing wall, together with a front wall and a back wall, and a side wall formed opposite the inner surface of the flanged wall, as shown by comparison in FIG. 2. In structural design, the internal receiving chamber formed in the first bite wing includes a selectively sealable fluid receiving opening formed within the front wall, wherein the fluid receiving opening may be configured for selectively receiving therethrough an amount of the fresh water, diluted mouthwash, or flavored fluid or gel introduced into the internal periphery of the receiving chamber upon introduction of a leading end of a delivery member, such as, for example but not by way of limitation, a syringe, containing a supply of the fluid or gel. Upon removal of the leading end of the delivery member after introducing the fresh water, diluted mouthwash, or flavored fluid or gel into the internal periphery of the receiving chamber, the fluid receiving opening formed within the front wall of the receiving chamber selectively reseals the internal periphery of the receiving chamber thereby providing means for retaining the amount of fluid or gel introduced into the internal receiving chamber of the first bite wing of the mouthpiece acting as a mouth guard.

Similar in configuration to the first bite wing, integrally formed between the upper surface and the opposing lower surface of the second bite wing is an internal receiving chamber having a periphery configured for receiving an amount of fresh water, diluted mouthwash, or a flavored fluid or gel. In one embodiment of the present invention, the internal receiving chamber may be defined by the upper and lower surfaces of the second bite wing correspondingly providing an upper wall and a lower opposing wall, together with a front wall and a back wall, and a side wall formed opposite the inner surface of the flanged wall, as shown by comparison in FIG. 2. In structural design, the internal receiving chamber formed in the second bite wing includes a selectively sealable fluid receiving opening formed within the front wall, wherein the fluid receiving opening may be configured for selectively receiving therethrough an amount of the fluid or gel introduced into the internal periphery of the receiving chamber upon introduction of a leading end of a delivery member, such as, for example but not by way of limitation, a syringe, containing a supply of fresh water, diluted mouthwash, or a flavored fluid or gel. Upon removal of the leading end of the delivery member after introducing the fluid or gel into the internal periphery of the receiving chamber, the fluid receiving opening formed within the front wall of the receiving chamber selectively reseals the internal periphery of the receiving chamber thereby providing means for retaining the amount of fluid or gel introduced into the internal receiving chamber of the second bite wing of the mouthpiece acting as a mouth guard.

In order to deliver an amount of the fresh water, diluted mouthwash, or flavored fluid or gel contained within the internal receiving chamber of the first bite wing of the mouth guard into the mouth of the user, at least one selectively sealable fluid delivery opening may be formed in the side wall of the internal receiving chamber and configured for selectively dispensing the fluid or gel therethrough upon an application of sufficient pressure or force applied by the teeth of the user to the upper and/or lower surfaces of the first bite wing. Upon application of pressure or sufficient force on the upper and/or lower surfaces of the first bite wing, an amount of the fresh water, diluted mouthwash, or flavored fluid or gel housed within the respective internal receiving chamber may be delivered through one or more selectively sealable fluid delivery openings formed in the corresponding side wall and into the user's mouth. In one embodiment of the present invention, two or more selectively sealable fluid delivery openings are formed in the side wall of the internal receiving chamber in the first bite wing in a spaced apart relationship to each other.

In addition to the one or more selectively sealable fluid delivery openings formed in the side wall of the internal receiving chamber formed in the first bite wing, in one embodiment of the present invention, at least one selectively sealable fluid delivery opening may be formed in at least a portion of the surface area of the upper surface of the first bite wing. Alternatively, at least two selectively sealable fluid delivery openings may be formed in the surface area of the upper surface in a spaced apart relationship to each other. As appreciated, the amount of fresh water, diluted mouthwash, or flavored fluid or gel that may be dispensed into the mouth of the user through at least one selectively sealable fluid delivery opening formed in the side wall of the internal receiving chamber and at least one selectively sealable fluid delivery opening formed in the upper surface of the first bite wing will depend on the need or desire of the user.

Additionally, in one embodiment of the present invention, at least two selectively sealable fluid delivery openings may be formed in the surface area of the upper surface of the second bite wing in a spaced apart relationship to each other. As appreciated, the amount of fresh water, diluted mouthwash, or flavored fluid or gel that may be dispensed into the mouth of the user through at least one selectively sealable fluid delivery opening formed in the side wall of the internal receiving chamber and at least one selectively sealable fluid delivery opening formed in the upper surface of the second bite wing will depend on the need or desire of the user. Upon application of pressure or sufficient force on the upper and/or lower surfaces of the second bite wing, an amount of the fluid or gel housed within the respective internal receiving chamber may be delivered through one or more selectively sealable fluid delivery openings formed in the corresponding side wall and into the user's mouth. In one embodiment of the present invention, two or more selectively sealable fluid delivery openings may be formed in the side wall of the internal receiving chamber in the second bite wing in a spaced apart relationship to each other.

One embodiment of the present invention contemplates that in addition to the one or more selectively sealable fluid delivery openings formed in the side wall of the internal receiving chamber formed in the first and/or second bite wings and/or the selectively sealable fluid delivery openings formed in the surface area of the upper surface of the first bite wing and the second bite wings, respectively, one or more selectively sealable fluid delivery openings may be formed in a spaced apart relationship in at least a portion of the surface area of the lower surface of the first bite wing and/or one or more selectively sealable fluid delivery openings may be formed in a spaced apart relationship in at least a portion of the surface area of the lower surface of the second bite wing. Thus, in accordance with such an embodiment of the present invention, upon application of pressure or sufficient force on the upper surfaces and/or the lower surfaces of the first and/or second bite wings, respectively, an amount of the fresh water, diluted mouthwash, or flavored fluid or gel contained within the respective internal receiving chamber will be delivered through one or more selectively sealable fluid delivery openings formed in the corresponding side wall and through one or more selectively sealable fluid delivery openings formed in the upper surface and/or through one or more selectively sealable fluid delivery openings formed in the lower surface of the first and/or second bite wings and into the user's mouth.

Alternatively, an alternate embodiment of a mouth guard of the present invention may may comprises a body portion configured for being selectively introduced into the mouth of a user, wherein the body portion comprises a flanged wall formed in a substantially semi-circular or “U” shaped configuration and defining an outer surface and an inner surface, with a thickness defined therebetween. The body portion may also be formed comprising a bite wing having an upper surface and an opposing lower surface disposed perpendicular to the inner surface of the flanged wall and wherein the bite wing forms a substantially U-shaped configuration complimentary to the shape of the flanged wall.

In one embodiment of the present invention, the upper surface of the bite wing may be formed having an extending upward bend formed at the furthermost width of the upper surface of the bite wing opposite and in spaced relation to the inner surface of the flanged wall, thereby forming an upper side wall or flange. The upper surface of the bite wing may also be generally configured having an extended surface area sufficient in size and dimension to engage at least some of the corresponding upper teeth of the user between the inner surface of the flanged wall and the upper side wall or flange of the bite wing therebetween.

The upper and lower surfaces of the bite wing may be formed having a smooth surface area for the corresponding teeth of the user to engage. In other embodiments of the mouth guard of the present invention, the upper and/or lower surfaces of the bite wing may be formed comprising a surface area, respectively, formed in such a manner to reduce slippage of the engaging teeth when the mouthpiece is inserted into the mouth of the user. For example, and not by way of limitation, the surface area of the upper and/or lower surfaces of the bite wing may be formed having a roughened surface area or a surface area including one or more raised nodules, both being sufficient for the teeth to engage, thereby reducing slippage of the engaging teeth when the mouth guard is inserted and retained within the mouth of the user.

Integrally formed between the upper surface and the opposing lower surface of the bite wing is an internal receiving chamber having a periphery configured for receiving an amount of fresh water, diluted mouthwash, or a flavored fluid or gel. In one embodiment of the present invention, the internal receiving chamber may be defined by at least a portion of the configuration of the upper and lower surfaces of the bite wing correspondingly providing an upper wall and a lower opposing wall, together with a front wall and a back wall, and a side wall formed opposite the inner surface of the flanged wall. In design, the internal receiving chamber formed in the bite wing includes a selectively sealable fluid receiving opening formed within at least a first front wall, wherein the fluid receiving opening may be configured for selectively receiving therethrough an amount of the fluid or gel introduced into the internal periphery of the receiving chamber upon introduction of a leading end of a delivery member, such as, for example but not by way of limitation, a syringe, containing a supply of the fresh water, diluted mouthwash, or flavored fluid or gel. Upon removal of the leading end of the delivery member after introducing the fluid or gel into the internal periphery of the receiving chamber, the fluid receiving opening formed within the front wall of the receiving chamber selectively reseals the internal periphery of the receiving chamber thereby providing means for retaining the amount of fresh water, diluted mouthwash, or flavored fluid or gel introduced into the internal receiving chamber of the bite wing of the mouth guard.

If desired, a single internal receiving chamber may be formed between the upper and lower surfaces of the bite wing, whereby having a corresponding semi-circular or U-shaped configuration and including one or more fluid receiving openings formed therein for introducing the fresh water, diluted mouthwash, or flavored fluid or gel into the one or more internal receiving chambers formed along at least a portion of the length of the bite wing.

In order to deliver the fluid or gel contained within at least one internal receiving chamber formed in the bite wing of the mouth guard into the mouth of the user, at least one selectively sealable fluid delivery opening may be formed along at least a portion of the length of the side wall of the internal receiving chamber and configured for selectively dispensing the fresh water, diluted mouthwash, or flavored fluid or gel therethrough upon an application of sufficient pressure or force applied by the teeth of the user to the upper and/or lower surfaces of the bite wing. Upon application of pressure or sufficient force on the upper and/or lower surfaces of the first bite wing, an amount of the fluid or gel housed within the respective internal receiving chamber may be delivered through one or more selectively sealable fluid delivery openings formed in the corresponding side wall and into the user's mouth. In one embodiment of the present invention, two or more selectively sealable fluid delivery openings may be formed in the side wall of the internal receiving chamber in the bite wing in a spaced apart relationship to each other.

In addition to the one or more selectively sealable fluid delivery openings formed in the side wall of the internal receiving chamber that may be formed in the first bite wing, another embodiment of the mouth guard of the present invention may comprise, at least one selectively sealable fluid delivery opening formed in at least a portion of the surface area of the upper and/or lower surfaces, respectively, of the bite wing. In one embodiment, at least two selectively sealable fluid delivery openings may be formed in the surface area of the upper and/or lower surfaces, respectively, in a spaced apart relationship to each other. As appreciated, the amount of fresh water, diluted mouthwash, or flavored fluid or gel that may be dispensed into the mouth of the user through at least one selectively sealable fluid delivery opening formed in the side wall of the internal receiving chamber and/or at least one selectively sealable fluid delivery opening formed in the upper and/or lower surfaces, respectively, of the bite wing will depend on the need or desire of the user.

As appreciated and as illustrated in the referenced Figures, one or more selectively sealable fluid delivery openings may be formed in relation to the embodiments of the mouthpiece and mouth guard of the present invention and which are presented in a variety of delivery configurations, each having the desired result of introducing the fresh water, diluted mouthwash, or flavored fluid or gel housed within the internal receiving chamber upon application of sufficient pressure or force applied by the user to the upper and/or lower surfaces of the bite wings thereby introducing the fluid or gel into the mouth of the user, as desired.

As contemplated herein, the flavored fluid or gel that may be introduced into the internal receiving chamber(s) of the mouthpiece may include a variety of flavors. The flavored fluid or gel, as contemplated by the present invention, may include sweetened or unsweetened flavors. For example, and not by way limitation, the flavored fluid or gel introduced into one or more of the receiving chambers formed in the opposing bite wings of the mouthpiece of the present invention may include the following flavors: grape, strawberry, berry, black cherry, blueberry, raspberry, coconut, banana, peach, chocolate, caramel, vanilla, mint, fruit punch, mango, bubble gum or the like. In addition, the flavored fluid or gel that is to be introduced into the receiving chamber of the first and/or second bite wings of the mouthpiece consists of a compositional solution or formulation that aids in overcoming and/or substantially ameliorating the discomfort and effects associated with salt mouth.

In one embodiment of the present invention, the fresh water, diluted mouthwash, or flavored fluid or gel may be first introduced into a delivery member, such as, for example, a syringe. The delivery member comprises a leading end having a size and shape sufficient for being introduced into the selectively sealable receiving opening formed in the front wall of the receiving chamber of the first and/or second bite wings to deliver an amount fresh water, diluted mouthwash, or a particular flavor of the flavored fluid or gel into the internal receiving chamber, as desired by the user. As contemplated herein, the internal receiving chamber formed within the opposing bite wings, respectively, may be configured to receive one or more flavors of the flavored fluid or gel as personally desired by the user.

With regards to the various embodiments of the mouthpieces, as illustrated in the Figures, and the various embodiments of the mouth guards as contemplated by the present invention, the mouthpieces and mouth guards may be formed of silicone, rubber or other suitable flexible material. As further appreciated, the mouthpieces and mouth guards of the present invention may be formed in various sizes, such as, extra small, small, medium, large or extra large, so as to provide a comfortable fit within the different sized mouths of users whereby resting comfortably between the upper and lower teeth of the particular user. It is further contemplated herein that the mouthpieces and mouth guards of the present invention may be provided in different colors or color combinations to provide a pleasing aesthetic value to a particular user. For example, and not intended to be by way of limitation, the material from which the mouthpiece may be made may comprise a color selected from the group consisting of red, blue, yellow, orange, green, violet, while, black or one or more combinations thereof.

Additionally, in one embodiment of the present invention, the silicone, rubber or other material from which the mouthpieces and mouth guards may be formed may comprise a flavoring embedded within the compositional material. In this regard, for example and not by way of limitation, the mouthpiece or mouth guard may be formed using a grape flavored silicone and include a grape flavored fluid or gel selectively introduced into one or more of the receiving chambers configured in one or more of the opposing bite wings. Whereas, upon application of a sufficient force or pressure applied by the user to the upper and/or lower surfaces of one or more of the bite wings, the grape flavoring introduced into the respective internal receiving chamber will pass through one or more selectively sealable fluid delivery openings formed in the side wall of the first and/or second receiving chamber and/or through one or more selectively sealable fluid delivery openings formed in the upper and/or lower surfaces of the first and/or second opposing bite wings.

As used herein, the term “selectively sealable” as it relates to the fluid receiving openings and the fluid delivery openings found in the various embodiments of the mouthpiece refers to openings that upon sufficient pressure or force open to allow fluid to enter into the internal receiving chamber or, alternatively, escape the internal periphery of the receiving chamber. Whereas, after being deformed under sufficient pressure or force, the fluid receiving openings and the fluid delivery openings return to their sealed position.

The present invention may be embodied in other specific forms without departing from its fundamental functions or essential characteristics. The described embodiments are to be considered in all respects only as illustrative, and not restrictive. All changes which come within the meaning and range of equivalency of the illustrative embodiments are to be embraced within their scope.

What is claimed and desired to be secured by United States Letters Patent is:

1. A mouthpiece configured for containing an amount of a fluid or gel and selectively delivering said fluid or gel into the mouth of a user, said mouthpiece comprising:
a first end configured for selectively engaging a receiving end selected from the group consisting of a snorkel or a diving regulator;
an opposing second end configured for being selectively introduced into said mouth of said user;
at least one receiving chamber formed in said second end, wherein said receiving chamber comprises an internal periphery configured for receiving an amount of said fluid or gel and having at least one selectively sealable fluid receiving opening formed therein for introducing said flavored fluid or gel into said receiving chamber; and
at least one selectively sealable fluid delivery opening formed in said second end, wherein said fluid delivery opening having a configuration for selectively delivering an amount of said fluid or gel from said receiving chamber into said mouth of said user.

2. The mouthpiece as defined in claim 1, wherein said mouthpiece is formed of a material selected from the group consisting of silicone, rubber or other suitable flexible material.

3. The mouthpiece as defined in claim 2, wherein said material comprises a flavor selected from the group consisting of grape, strawberry, berry, black cherry, blueberry, raspberry, coconut, banana, peach, chocolate, caramel, vanilla, mint, fruit punch, mango, bubble gum or the like.

4. The mouthpiece as defined in claim 2, wherein said material comprises a color selected from the group consisting of red, blue, yellow, orange, green, violet, white, black or combinations thereof.

5. The mouthpiece as defined in claim 1, further comprising an internal conduit formed within at least a portion of said first and second ends and configured to allow for the passage of air between said snorkel or said diving regulator and said mouth of said user.

6. The mouthpiece as defined in claim 1, further comprising at least two selectively sealable fluid delivery openings formed in said second end in fluid relationship with at least two receiving chambers, respectively.

7. The mouthpiece as defined in claim 1, wherein said second end comprises a flanged wall having a substantially semi-circular shape, wherein said flanged wall includes an inner surface, an outer surface and a thickness defined therebetween.

8. The mouthpiece as defined in claim 7, further comprising a first bite wing engaging at least a portion of said inner surface of said flanged wall, wherein said first bite wing comprises:
an upper surface and an opposing lower surface disposed substantially perpendicular to said inner surface of said flanged wall;
said upper surface of said first bite wing comprising a surface area and an upwardly extending side wall formed along at least a portion of said upper surface disposed opposite said engagement of said first bite wing in relation to said inner surface of said flanged wall, wherein said surface area of said upper surface being configured to engage some of the corresponding upper teeth of said user between said inner surface of said flanged wall and said upwardly extending side wall; and
said lower surface of said first bite wing comprising a surface area and a downwardly extending side wall formed along at least a portion of said lower surface disposed opposite said engagement of said first bite wing with said inner surface of said flanged wall, wherein said surface area of said lower surface being configured to engage some of the corresponding lower teeth of said user between said inner surface of said flanged wall and said downwardly extending side wall.

9. The mouthpiece as defined in claim 8, wherein said surface area of said upper surface of said first bite wing comprises at least one selectively sealable fluid delivery opening.

10. The mouthpiece as defined in claim 8, wherein said surface area of said lower surface of said first bite wing comprises at least one selectively sealable fluid delivery opening.

11. The mouthpiece as defined in claim 8, wherein said surface areas of said upper and lower surfaces of said first bite wing, respectively, comprise two or more selectively sealable fluid delivery openings.

12. The mouthpiece as defined in claim 8, wherein said surface areas of said upper and lower surfaces of said first bite wing, respectively, may be selected from the group consisting of smooth, etched, roughened or raised in the form of nodules.

13. The mouthpiece as defined in claim 8, wherein said receiving chamber is defined by the upper and lower surfaces of the first bite wing correspondingly providing an upper wall and a lower wall, respectively, and further comprising a front wall, a back wall and a side wall formed opposite said inner surface of said flanged wall.

14. The mouthpiece as defined in claim 8, further comprising a second bite wing engaging at least a portion of said inner surface of said flanged wall opposite the disposition of said first bite wing, wherein said second bite wing comprises:
an upper surface and an opposing lower surface disposed substantially perpendicular to said inner surface of said flanged wall;
said upper surface of said second bite wing comprising a surface area and an upwardly extending side wall formed along at least a portion of said upper surface disposed opposite said engagement of said second bite wing in relation to said inner surface of said flanged wall, wherein said surface area of said upper surface being configured to engage some of the corresponding upper teeth of said user between said inner surface of said flanged wall and said upwardly extending side wall; and
said lower surface of said second bite wing comprising a surface area and a downwardly extending side wall formed along at least a portion of said lower surface disposed opposite said engagement of said second bite wing with said inner surface of said flanged wall, wherein said surface area of said lower surface being configured to engage some of the corresponding lower teeth of said user between said inner surface of said flanged wall and said downwardly extending side wall.

15. The mouthpiece as defined in 14, wherein said surface area of said upper surface of said second bite wing comprises at least one selectively sealable fluid delivery opening.

16. The mouthpiece as defined in claim 14, wherein said surface area of said lower surface of said second bite wing comprises at least one selectively sealable fluid delivery opening.

17. The mouthpiece as defined in claim 14, wherein said surface areas of said upper and lower surfaces of said second bite wing, respectively, comprise two or more selectively sealable fluid delivery openings.

18. The mouthpiece as defined in claim 14, wherein said surface areas of said upper and lower surfaces of said second bite wing, respectively, may be selected from the group consisting of smooth, etched, roughened or raised as in the form of nodules.

19. The mouthpiece as defined in claim 1, wherein said fluid or gel is selected from the group consisting of fresh water, diluted mouthwash, or a flavored fluid or gel comprising sweetened or unsweetened flavors selected from the group consisting of grape, strawberry, berry, black cherry, blueberry, raspberry, coconut, banana, peach, chocolate, caramel, vanilla, mint, fruit punch, mango, bubble gum or the like.

20. The mouthpiece as defined in claim 1, wherein said second end comprises various sizes selected from the group consisting of extra small, small, medium, large or extra large, wherein said sizes being formed to provide a comfortable fit within the mouth of said user.
